(19) United States
(12) Patent Application Publication
(10) Pub. No.: US 2026/0246681 A1
(43) Pub. Date: Aug. 20, 2026

(54) ORTHOGONAL TIME FREQUENCY BASED TRANSMISSIONS IN NEXT GENERATION WIRELESS SYSTEMS

(71) Applicant: WISIG NETWORKS PRIVATE LIMITED, Madinaguda, Hyderabad (IN)

(72) Inventors: Koteswara Rao Gudimitla, Srikalahasti, Andhra Pradesh (IN); Sibgath Ali Khan Makandar, Khizra Enclave, Hyderabad (IN)

(21) Appl. No.: 19/165,378

(22) PCT Filed: Mar. 17, 2024
(86) PCT No.: PCT/IN2024/050277

§ 371 Date: Sep. 15, 2025

(30) Foreign Application Priority Data
Mar. 17, 2023 (IN) 202341018066

(51) Int. Cl. H04L 27/26

(52) U.S. Cl. CPC H04L 27/2613; H04L 27/2607

(57) ABSTRACT

Embodiments of the present disclosure relate methods and systems for transmitting downlink Orthogonal time frequency-division multiplexing (OTFDM) symbol. The method comprising time-multiplexing, by the transmitter, at least one of a primary synchronization signal (PSS) sequence, a secondary synchronization signal (SSS) sequence and a physical broadcast channel (PBCH) sequence and a portion of the at least one of PSS sequence, SSS sequence and PBCH sequence to generate a multiplexed sequence. Also, the method comprises filtering the multiplexed sequence to generate a synchronized signal (SS) Block OTFDM symbol. Also, a method for transmitting OTFDM SS burst comprising time-multiplexing a plurality of OTFDM SS Blocks to generate multiplexed OTFDM SS blocks is provided. Each of the plurality of OTFDM SS Blocks is associated with a different beam. Further, methods disclosed relate to generation and transmission of one of PDCCH OTFDM symbol, PDSCH OTFDM symbol, PDCCH-PDSCH OTFDM symbol, PDCCH-PDSCH OTFDM slot and downlink frame.

### CROSS-REFERENCE TO RELATED APPLICATIONS

This application claims priority from the Indian Provisional Patent Application No. 202341018066, filed on 17 Mar. 2023, the entirety of which are hereby incorporated by reference.

### TECHNICAL FIELD

Embodiments of the present disclosure are related, in general to communication, but exclusively relate to methods and systems for generating and transmitting downlink OTFDM symbol.

### BACKGROUND

3GPP (3rd Generation Partnership Project) has developed 5G-NR standards to support use cases like eMBB, URLLC, MMTC. To support multiple access OFDMA has been agreed to use in current 5G-NR. However, in previous standards different Multiple access techniques have been studied and used, like in 2G TDMA, 3G is based on CDMA and relied on OFDMA. OFDM, in spite of many of its attractive properties, has a critical drawback i.e., low power-amplifier efficiency (low energy efficiency).

The communications latency is fundamentally limited by the delay before a transfer of data begins following an instruction for its transfer. This delay is equal to the duration of a “slot” which is a basic unit of information transmission that comprises of data/control and reference signals. A slot in OFDM systems comprises of multiple data symbols and one or more reference symbols. 4G uses 0.5 ms slot and 5G NR specifications allow URLLC using 0.125 ms. In order to achieve low latency 5G NR uses mini slots where the duration of the slot is two OFDM symbols. To achieve Extremely Low Latency Communication (ELLC) it is preferable to use a single OFDM symbol to transmit the information. Basic OFDM allows frequency multiplexing of reference signal and data/control within one OFDM symbol. Our chief aim is to use high energy efficiency waveform such as DFT-S-OFDM (it is a variant of OFDM with low-PAPR and is used in both 4G and 5G); this waveform requires a dedicated OFDM symbol for the transmission of RS and an additional symbol for data, thus resulting in two symbols duration (In conventional DFT-S-OFDM, RS is not time multiplexed with data in one OFDM symbol since this multiplexed RS does not offer reliable estimation of the channel impulse response). The RS is required for the purpose of estimating the channel state information (CSI) and subsequent equalization of data symbol. This two-symbol structure not only doubles the latency (compared to single symbol case), but also has a higher RS overhead i.e., 50%. There is a need for a new type of waveform that allows one shot transmission with flexible RS overhead and high-power efficiency. 6G Mobile Communication System requires a method of information transmission and that offers extremely low latency, very high data rate, and very high-power efficiency.

In an illustration of a wireless communication network, a base station (BS) is in communication with multiple users, also referred as user equipment's (UEs) or user device or mobile or mobile device. The BS is also referred to as cell or gnB. The FIG. 0 further shows an uplink and downlink i.e. two-way communication links between the BS and UEs. These measure the bandwidth and signal strength of data transmission between a user device and a base station or access point. The uplink is the transmission of data from a user device to a base station. Downlink is the transmission of data from a base station to a user device. For example, when a mobile device initiates a call, it establishes a wireless connection on an uplink frequency to a cell tower or base station. The base station then amplifies the signal and sends it on a downlink frequency to the intended recipient.

A cell ID number is a unique identifier assigned to each cell tower by a cellular network. This identifier is used to distinguish one cell tower from another and is crucial for routing calls and text messages to the correct tower. In wireless communication networks, cells are divided into different sectors, and each sector is assigned a unique Physical Cell ID.

There is a need for a waveform technology that not only addresses this critical issue of improving energy efficiency but also achieves extremely low latency. Current 5G standards uses slot structure, where user data is transmitted in series of OFDM symbols. A typical slot structure comprises of one or more data symbols and one or more reference symbols.

### SUMMARY

The shortcomings of the prior art are overcome and additional advantages are provided through the provision of method of the present disclosure.

Additional features and advantages are realized through the techniques of the present disclosure. Other embodiments and aspects of the disclosure are described in detail herein and are considered a part of the claimed disclosure.

In one aspect of the present disclosure a method for transmitting synchronization signal (SS) Block Orthogonal time frequency-division multiplexing (OTFDM) symbol is disclosed. The method comprising time-multiplexing, by the transmitter, at least one of a primary synchronization signal (PSS) sequence, a secondary synchronization signal (SSS) sequence, a physical broadcast channel (PBCH) sequence, and a portion of the at least one of PSS sequence, SSS sequence and PBCH sequence to generate a multiplexed sequence. Also, the method comprises processing, by the transmitter, the multiplexed sequence to generate a SS Block OTFDM symbol.

In another aspect of the present disclosure a method for transmitting OTFDM SS burst is provided. The method comprising time-multiplexing, by the transmitter, a plurality of OTFDM SS Blocks to generate multiplexed OTFDM SS blocks, wherein each of the plurality of OTFDM SS Blocks is associated with a different beam.

In yet another aspect of the present disclosure a method for transmitting OTFDM SS burst is provided. The method comprising time-multiplexing, by the transmitter, a plurality of OTFDM SS Blocks to generate multiplexed OTFDM SS blocks, wherein each of the plurality of OTFDM SS Blocks is associated with a different beam.

In yet another aspect of the present disclosure a method for transmitting OTFDM SS burst is provided. The method comprising time-multiplexing, by the transmitter, a plurality of pre-DFT SS Blocks and guard blocks to generate a time multiplexed block, wherein each of the plurality of pre-DFT SS Blocks comprises a PSS, a SSS and a PBCH, said each of the plurality of pre-DFT SS block is associated with a beam. Also, the method comprises filtering, by the transmitter, the multiplexed block using OTFDM generation unit to generate OTFDM SS burst.

In yet another aspect of the present disclosure a method for transmitting a PDCCH-PDSCH Orthogonal time frequency-division multiplexing (OTFDM) symbol is provided. The method comprising time-multiplexing, by the transmitter, at least one of a physical downlink control channel (PDCCH) sequence, a physical downlink shared channel (PDSCH) sequence, a reference sequence (RS), and a portion of at least one of the PDCCH sequence, the PDSCH sequence and the RS to generate a multiplexed sequence. Also, the method comprises filtering, by the transmitter, the multiplexed sequence to generate a PDCCH-PDSCH OTFDM symbol.

In yet another aspect of the present disclosure a method for transmitting a PDSCH Orthogonal time frequency-division multiplexing (OTFDM) symbol is provided. The method comprising time-multiplexing, by the transmitter, a physical downlink shared channel (PDSCH) sequence, a reference sequence (RS), and a portion of at least one of the PDSCH sequence and the RS to generate a multiplexed sequence. Also, the method comprises filtering, by the transmitter, the multiplexed sequence to generate a PDSCH OTFDM symbol.

In yet another aspect of the present disclosure a method for transmitting a PDCCH Orthogonal time frequency-division multiplexing (OTFDM) symbol is provided. The method comprising time-multiplexing, by the transmitter, a physical downlink shared channel (PDSCH) sequence, a reference sequence (RS), and a portion of at least one of the PDSCH sequence and the RS to generate a multiplexed sequence. Also, the method comprises filtering, by the transmitter, the multiplexed sequence to generate a PDSCH OTFDM symbol.

In yet another aspect of the present disclosure a method for transmitting a PDCCH-PDSCH Orthogonal time frequency-division multiplexing (OTFDM) slot is provided. The method comprising time-multiplexing, by the transmitter, a PDCCH-PDSCH OTFDM symbol and a plurality of PDSCH OTFDM symbols to generate a PDCCH-PDSCH Orthogonal time frequency-division multiplexing (OTFDM) slot.

In yet another aspect of the present disclosure a method for transmitting a PDCCH-PDSCH Orthogonal time frequency-division multiplexing (OTFDM) slot is provided. The method comprising time-multiplexing, by the transmitter, a PDCCH OTFDM symbol, a plurality of PDSCH OTFDM symbols to generate a PDCCH-PDSCH Orthogonal time frequency-division multiplexing (OTFDM) slot.

In yet another aspect of the present disclosure method for transmitting a downlink frame is provided. The method comprising time-multiplexing, by the transmitter, at least one SS Block and at least PDCCH-PDSCH OTFDM slot to generate at least one downlink signal associated with a beam.

In yet another aspect of the present disclosure a method for transmitting a downlink frame is provided. The method comprising time-multiplexing, by the transmitter, a plurality of SS Blocks associated with a plurality of beams and a plurality of PDCCH-PDSCH OTFDM symbols associated with a plurality of beam to generate a downlink frame.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of device or system and/or methods in accordance with embodiments of the present subject matter are now described, by way of example only, and with reference to the accompanying figures, in which:

FIG. 1A shows a block diagram of an orthogonal time frequency division multiplexing (OTFDM) transmitter, in accordance with an embodiment of the present disclosure;

FIG. 1B shows a block diagram of an OTFDM symbol generating unit, in accordance with an embodiment of the present disclosure;

FIG. 1C shows a block diagram of a processing unit of the OTFDM symbol generating unit as shown in FIG. 1B, in accordance with an embodiment of the present disclosure;

FIG. 1D shows a block diagram of a processing unit of the OTFDM symbol generating unit as shown in FIG. 1B, in accordance with another embodiment of the present disclosure

FIG. 1E shows a block diagram illustration of an OTFDM transmitter for generating an OTFDM waveform, in accordance with an alternate embodiment of the present disclosure;

FIGS. 2A-2B shows symbol structure or block of primary synchronization signal (PSS) sequence;

FIGS. 2C-2D shows symbol structure or block of secondary synchronization signal (SSS) sequence;

FIGS. 2E-2H shows various symbol structure with PBCH data and optional PTRS;

FIG. 2I shows an illustration of different OTFDM Symbol carrying SSB, in accordance with an embodiment of the present disclosure;

FIG. 2J shows an example illustration of a PSS sequence;

FIG. 2L shows an illustration of a SS Block, in accordance with an embodiment of the present disclosure;

FIG. 2M shows an illustration of a SS Block, in accordance with another embodiment of the present disclosure;

FIG. 2N shows an illustration of a SS Block, in accordance with another embodiment of the present disclosure;

FIG. 3A shows an illustration of PSS, SSS, PBCH carried in one OTFDM SSB symbol, in accordance with an embodiment of the present disclosure;

FIG. 3B shows an illustration of multiple SS block OTFDM symbols in a slot;

FIG. 3C shows an illustration of multiple SS block OTFDM symbols in a slot associated with different beams;

FIG. 3D shows a beam sweeping over successive OTFDM symbols, in a downlink transmitter;

FIG. 3E shows a beam sweeping in a single OTFDM symbol, in a downlink transmitter;

FIG. 3F shows an illustration of generation of an OTFDM symbol where two SS blocks are time multiplexed and each SS block is associated with a different beam;

FIG. 4A shown an illustration of generation of PSS OTFDM symbol, SSS OTFDM symbol and PBCH OTFDM symbol;

FIG. 4B shows an illustration of an SS block consisting of 3 OTFDM symbols in time;

FIG. 4C shows an illustration SS block consisting of 2 OTFDM symbols in time;

FIG. 4D illustrates the transmission of SS burst, where multiple SS blocks are transmitted in a half frame;

FIG. 4E shows an illustration of PSS symbol;

FIG. 4F shows an illustration of SSS symbol;

FIG. 4G shows a beam sweeping over successive OTFDM symbols;

FIG. 4H shows a synchronization channel structure in a beam sweeping systems;

FIG. 5A shows a block diagram of an OTFDM transmitter, in accordance with another embodiment of the present disclosure;

FIG. 5B shows an illustration of different OTFDM Symbol carrying downlink channels;

FIG. 6A shows various symbol structure with PDCCH data and optional PTRS with RS;

FIG. 6B shows a symbol structure of PDCCH data, in accordance with an embodiment;

FIG. 6C shows a symbol structure with PDCCH data and optional PTRS, in accordance with an embodiment of the present disclosure;

FIG. 6D shows a symbol structure with PDCCH data and optional PTRS, in accordance with an embodiment of the present disclosure;

FIGS. 6E-6H shows various symbol structure with PDSCH data and optional PTRS;

FIGS. 7A-7D shows various symbol structure with PDCCH plus PDSCH data and optional PTRS;

FIGS. 7E-7H shows various symbol structure of PSS, SSS, PBCH, PDCCH and PDSCH data;

FIGS. 7J-7L shows various symbol structure of SSB, PDCCH and PDSCH, PSS and SSS channel data;

FIGS. 8A-8C shows various symbol structure of RS, PDCCH, PDSCH channel data, in accordance with some embodiments of the present disclosure;

FIGS. 8D-8E shows various symbol structure of SSB, PDCCH and PDSCH, PSS and SSS channel data, in accordance with another embodiment of the present disclosure

FIG. 9 shows a block diagram of an OTFDM transmitter, in accordance with an exemplary embodiment of the present disclosure;

FIG. 10 shows the generation of a single OTFDM symbol;

FIG. 11 shows allocation of SS block, PDCCH and PDSCH OTFDM symbols in a slot with their associated beam, where a slot has N symbols;

FIG. 12 shows allocation of SS block, PDCCH and PDSCH OTFDM symbols in a frame with their associated beam, where a slot consisting of 1 OTFDM symbol;

FIG. 13 illustrates the sequence of messages exchanged between a UE and a gNB till RRC connection is established;

FIG. 14A shows a block diagram representation of a receiver, in accordance with an embodiment of the present disclosure;

FIG. 14B shows the receiver block diagram for SSS receiver; and

FIG. 14C shows a block diagram representation of a PSS receiver, in accordance with yet another embodiment of the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a device or system or apparatus proceeded by “comprises . . . a” does not, without more constraints, preclude the existence of other elements or additional elements in the device or system or apparatus.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise. The terms “including”, “comprising”, “having” and variations thereof mean “including but not limited to”, unless expressly specified otherwise. The enumerated listing of items does not imply that any or all of the items are mutually exclusive, unless expressly specified otherwise. The terms “a”, “an” and “the” mean “one or more”, unless expressly specified otherwise.

The present disclosure provides a waveform technology that not only addresses this critical issue of improving energy efficiency but also achieves one of the major goals of future wireless communication systems i.e., extremely low latency. Current 5G standards uses slot structure, where user data is transmitted in series of OFDM symbols. A typical slot structure comprises of one or more data symbols and one or more reference symbols.

Embodiments of the present disclosure provides a new waveform which allows synchronization channels such as PSS, SSS and PBCH and control channels PDCCH, data channel PDSCH to be transmitted with low PAPR, high PA efficiency, low latency using multiple antenna ports or beams. The embodiments illustrate how low latency is obtained from entire system operation point of view.

Embodiments of the present disclosure provides a new type of waveform that allows time division multiplexing of data/control and RS within a single OTFDM symbol (TDM within a OTFDM Symbol). The generated symbol is referred to as orthogonal time frequency division multiplexing (OTFDM) symbol, which is designed for information exchange taking place in one shot transmission. The duration of the OTFDM symbol (or subcarrier width) is to meet the overall latency requirement.

In a downlink (DL) transmission, a communication system or transmitter uses a method of TDM of user data/control/RS and also common channels such as PSS, SSS, PBCH using OTFDM waveform. However, multiple services and multiple numerologies can be frequency multiplexed using FDM based on the BWP concept that uses WOLA/filtering for frequency multiplexing of these services.

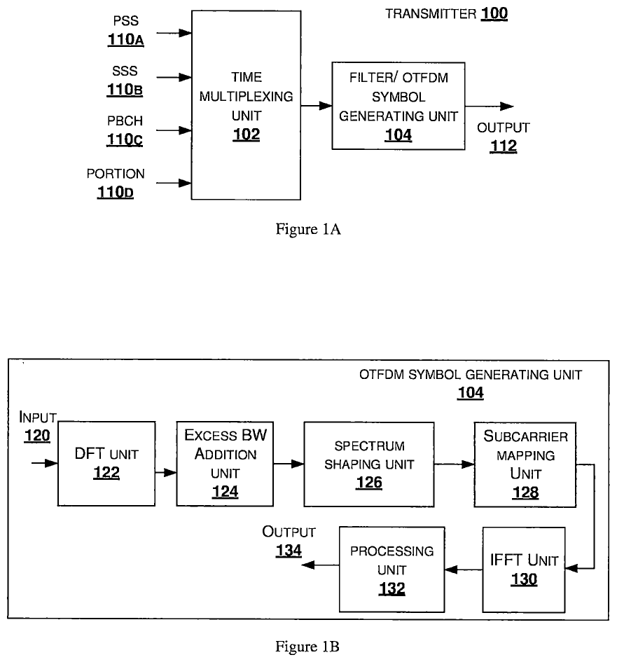

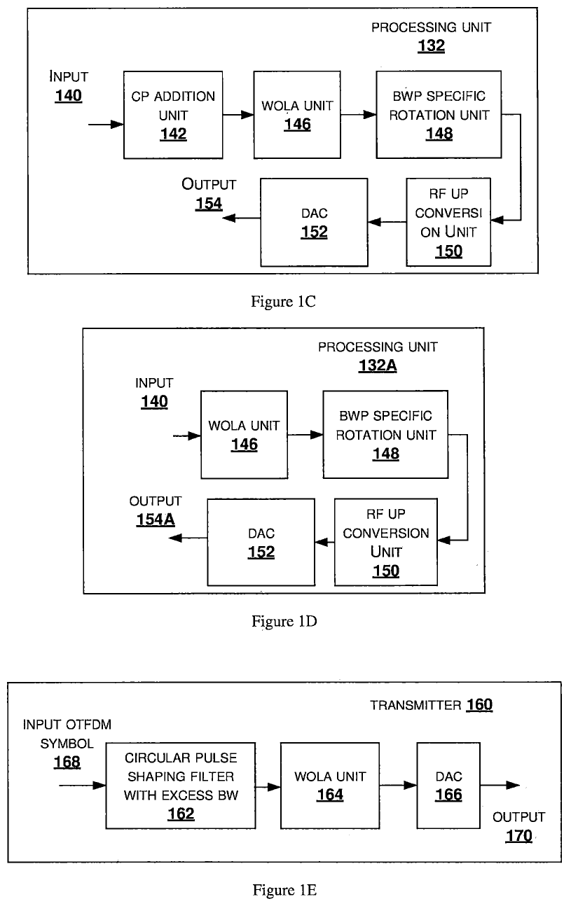

FIG. 1A shows a block diagram of an OTFDM transmitter, in accordance with an exemplary embodiment of the present disclosure. The OTFDM transmitter is referred to as a transmitter or a communication system.

As shown in the FIG. 1A, the transmitter 100 comprises a time multiplexing unit 102 and an OTFDM symbol generating unit 104. The time multiplexing unit 102 is also referred as a time multiplexer or multiplexer or time division multiplexer or TDM. Also, the transmitter 100 comprises a plurality of antennas. The OTFDM symbol generating unit 104 is also referred as OTFDM symbol generator or symbol generator.

In an embodiment, the time multiplexer 102 multiplexes a PSS sequence 110A, an SSS sequence 110B, a PBCH sequence 110C, and a portion of the at least one of PSS sequence, SSS sequence and PBCH sequence 110D to generate a multiplexed sequence. The multiplexed sequence is also referred to as time multiplexed sequence or TDM sequence or pre-DFT symbols. The symbols shown in the below Figures are the multiplexed sequences obtained using time multiplexer 102.

The OTFDM symbol generating unit 104 generates an output 134 called as OTFDM symbol using the multiplexed sequences. The multiplexed sequence is obtained by time multiplexing the PSS sequence, the SSS sequence, PBCH sequence and a portion of the at least one of PSS sequence, SSS sequence and PBCH sequence. The generated symbol is referred as synchronization signal (SS) Block Orthogonal time frequency-division multiplexing (OTFDM) symbol or SS Block OTFDM symbol.

In an embodiment, the multiplexed sequence is fed to the filter or OTFDM symbol generating unit 104, to generate a OTFDM symbols specific to a particular antenna. The symbol generated is transmitted by one of a specific antenna from the plurality of antennas.

In another embodiment, the generated OTFDM waveform undergoes a procedure known as Antenna precoding, where the purpose of precoding is to map the generated OTFDM symbols to a set of antenna ports using a precoder matrix. The generated OTFDM signal is multiplied using antenna port specific phase weights and each weighted signal is transmitted using an antenna port. Each complex weighted baseband OTFDM signal is converted to analog waveform using digital to analog converter (DAC). The analog OTFDM waveform undergoes power amplification to boost the signal strength to a level capable of transmission across the air interface. Since, OTFDM signal has low PAPR, the PA requires low back off, thereby resulting in energy efficient transmission. For pi/2 BPSK OTFDM the back off may be 0 dB or very low value so that signal can be transmitted close to power amplifier (PA) saturation power. Digital pre distortion operation may be used before PA when higher order modulation is used. Further the OTFDM waveform undergoes radio frequency (RF) filtering subsequently transmitted through the antenna array.

In an embodiment, the generated OTFDM symbol is a SS Block OTFDM symbol. The SS Block OTFDM symbol is one of a PSS OTFDM symbol comprising of only PSS sequence, a SSS OTFDM symbol comprising of only SSS sequence, a PBCH OTFDM symbol comprising of only PBCH sequence; and an OTFDM symbol comprising of the PSS sequence, the SSS sequence, the PBCH sequence and a portion of the at least one of PSS sequence, SSS sequence and PBCH sequence.

The PSS sequence includes one of a PSS cyclic prefix (CP), and a PSS CP along with a PSS cyclic suffix (CS). The SSS sequence includes one of a SSS CP and a SSS CP along with a SSS CS. The PBCH sequence includes one of a PBCH CP, and a PBCH CP along with PBCH CS. In an embodiment, the PBCH sequence includes a PBCH DMRS, said PBCH DMRS includes at least one of a PBCH DMRS CP and a PBCH DMRS CS. The PBCH DMRS is one of a pi/2 BPSK, a QPSK, and a ZC, wherein the PBCH data is one of a pi/2 BPSK and a QPSK.

The PSS sequence is a function of sector id or Base station id, wherein the PSS sequence is one sequence for all sectors or one of N possible sequences, wherein N is an integer. The PSS sequence is one of pi/2 BPSK and ZC; wherein the SSS sequence is one of pi/2 BPSK and ZC. In an embodiment, the PSS sequence comprise a base sequence repeated for a predefined number of times, wherein each of the repeated based sequence is multiplied with an element of a code cover sequence. The SSS sequence comprises of a base sequence repeated for a predefined number of times, wherein each of the repeated based sequence is multiplied with an element of a code cover sequence. The predefined number is one of 1, 2, 4 or more.

FIG. 1B shows a block diagram of an OTFDM symbol generating unit or filter 104, in accordance with an embodiment of the present disclosure. As shown in the FIG. 1B, the OTFDM symbol generating unit 104 comprises a Discrete Fourier Transform (DFT) unit 122, an excess BW addition unit 124, a spectrum shaping unit 126, a sub-carrier mapping unit 128, an inverse Fast Fourier transform (FFT) unit 130 and a processing unit 132.

The DFT unit 122 transforms an input 120 i.e. multiplexed sequence using a Discrete Fourier Transform (DFT) to generate a transformed multiplexed sequence. The input 120 is time multiplexed sequence of a PSS sequence 110A, an SSS sequence 110B, a PBCH sequence 110C, and a portion of the at least one of PSS sequence, SSS sequence and PBCH sequence 110D. In an embodiment, the input is time multiplexed sequence of a PSS sequence 110A, an SSS sequence 110B and a PBCH sequence 110C.

The excess BW addition unit 124 performs padding operation on the transformed multiplexed sequence i.e. prefixing the transformed multiplexed sequence with a first predefined number (N1) of subcarriers and post-fixing the transformed multiplexed sequence with a second predefined number (N2) of subcarriers to obtain an extended bandwidth transformed multiplexed sequence. The value of the N1 is at least zero, and value of the N2 is at least zero. The values of N1 and N2 may be same or different. The value of N1 and N2 may depend on the excess power that is sent by the transmitter.

The spectrum shaping unit 126, also referred as a shaping unit or a filter, performs shaping of the extended bandwidth transformed multiplexed sequence to obtain a shaped extended bandwidth transformed multiplexed sequence or shaped sequence. The filter used for the shaping operation on the extended bandwidth transformed multiplexed sequence is one of a Nyquist filter, square root raised cosine filter, a raised cosine filter, a hamming filter, a Hanning filter, a Kaiser filter, an oversampled GMSK filter and any filter that satisfies predefined spectrum characteristics.

The sub carrier mapping unit 128, also referred as a mapper or a sub carrier mapper or a mapping unit, performs subcarrier mapping on the shaped extended bandwidth transformed multiplexed sequence or shaped sequence with at least one of localized and distributed subcarriers to generate a mapped extended bandwidth transformed multiplexed sequence. In an embodiment, the distributed subcarrier mapping includes insertion of zeros in to the extended bandwidth transformed multiplexed sequence.

The IFFT unit 130 performs inverse IFFT on the shaped extended bandwidth transformed multiplexed sequence to produce a time domain sequence. The time domain sequence is processed by the processing unit 132 to generate an OTFDM symbol.

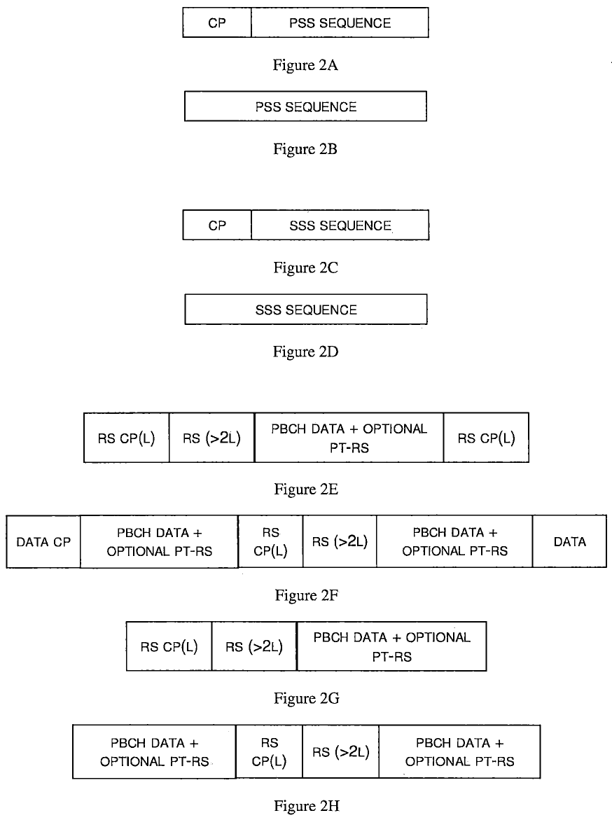

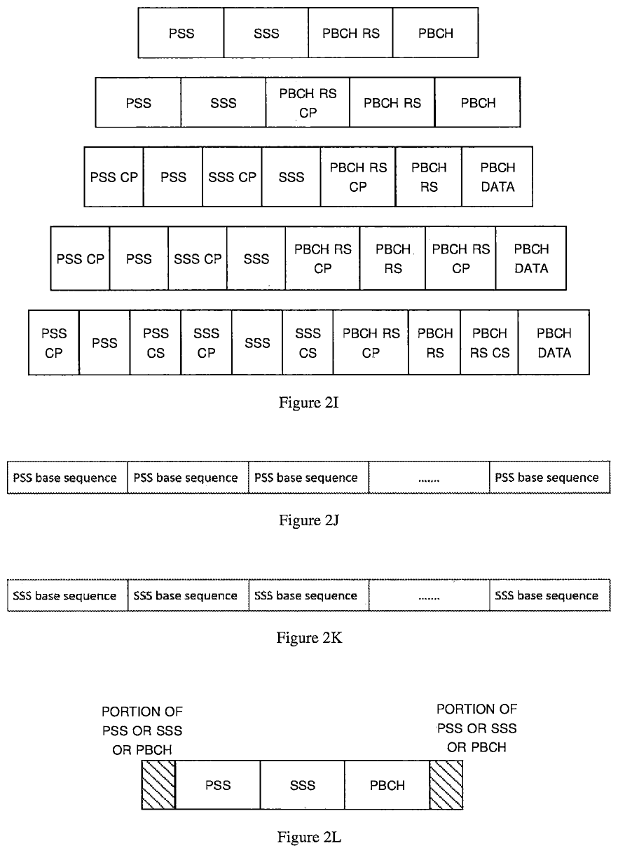

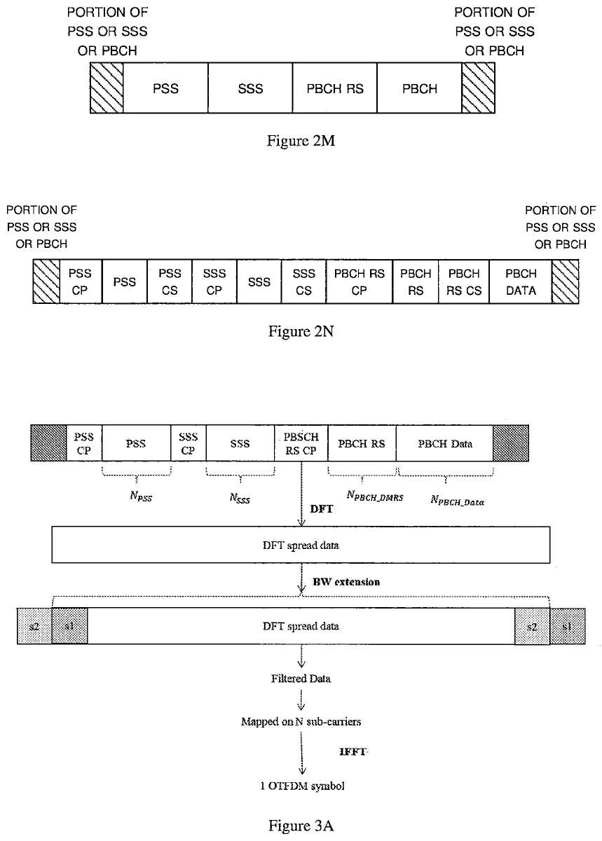

The input to the Filter 120 is a time multiplexed sequence, which is one of the symbol structures as shown in the FIGS. 2A-2D, 2F, 2G, 2I. The generated output 134 is fed to the processing unit as shown in FIG. 1C.

FIG. 1C shows a block diagram of a processing unit of the OTFDM symbol generating unit as shown in FIG. 1B, in accordance with an embodiment of the present disclosure. As shown in FIG. 1C, the processing unit 132 comprises a cyclic prefix (CP) addition unit 142, a weighted with overlap and add operation (WOLA) unit 146, a bandwidth parts (BWP) specific rotation unit 148, a RF up-conversion unit 150, and a digital to analog converter (DAC).

The processing unit 132 processes an input 140 i.e. the time domain sequence to generate an OTFDM symbol. The processing comprises performing at least one of a symbol specific phase compensation, an addition of symbol cyclic prefix using the CP addition unit 142, addition of symbol cyclic suffix, windowing, weighted with overlap and add operation (WOLA) using the WOLA unit 146, bandwidth parts (BWP) rotation using BWP specific rotation unit 148, an additional time domain filtering, sampling rate conversion to match DAC rate, frequency shifting on the time domain waveform using RF up conversion unit 150 and converting the same into analog using the DAC 152, to generate the output OTFDM symbol 154. The generated OTFDM symbol offers low PAPR.

One embodiment of the present disclosure is a method for transmitting synchronization signal (SS) Block Orthogonal time frequency-division multiplexing (OTFDM) symbol. The order in which the method steps is described is not intended to be construed as a limitation, and any number of the described method steps can be combined in any order to implement the method. Additionally, individual method steps may be deleted from the methods without departing from the scope of the subject matter described herein. Furthermore, the method can be implemented in any suitable hardware, software, firmware, or combination thereof.

The method comprising time-multiplexing, by the transmitter, at least one of a primary synchronization signal (PSS) sequence, a secondary synchronization signal (SSS) sequence, a physical broadcast channel (PBCH) sequence and a portion of the at least one of PSS sequence, SSS sequence and PBCH sequence to generate a multiplexed sequence. Thereafter, filtering is performed on the multiplexed sequence to generate a synchronization signal (SS) Block OTFDM symbol.

The method of filtering the multiplexed sequence to generate the SS Block OTFDM symbol comprising transforming the multiplexed sequence using a Discrete Fourier Transform (DFT) to generate a transformed multiplexed sequence. The method comprises performing padding operation by prefixing the transformed multiplexed sequence with a first predefined number (N1) of subcarriers and post-fixing the transformed multiplexed sequence with a second predefined number (N2) of subcarriers to obtain an extended bandwidth transformed multiplexed sequence. The value of the N1 is at least zero, and value of the N2 is at least zero.

Also, the method comprises mapping the extended bandwidth transformed multiplexed sequence with at least one of localized and distributed subcarriers to generate a mapped extended bandwidth transformed multiplexed sequence. A shaping is performed on the mapped extended bandwidth transformed multiplexed sequence using a filter to obtain a shaped extended bandwidth transformed multiplexed sequence.

Further, the method comprises performing an Inverse Fast Fourier Transform (IFFT) on the shaped extended bandwidth transformed multiplexed sequence to produce a time domain sequence. Thereafter, the method comprises processing the time domain sequence to generate the OTFDM symbol. This processing of the time domain sequence to generate a OTFDM symbol comprises performing at least one of addition of symbol cyclic prefix, addition of symbol cyclic suffix, phase compensation for each symbol by multiplying with a symbol specific exponential value, windowing, weighted with overlap and add operation (WOLA), bandwidth parts (BWP) rotation, additional time domain filtering, sampling rate up-conversion to match DAC rate and frequency shifting on the time domain waveform, to generate the OTFDM symbol.

In another embodiment, the transmitter 100 comprises the filter or OTFDM symbol generating unit 104 which generates an output OTFDM symbol without CP addition. The OTFDM symbol generating unit 104 comprising Discrete Fourier Transform (DFT) unit 122, an excess BW addition unit 124, a spectrum shaping unit 126, a sub-carrier mapping unit 128, an inverse Fast Fourier transform (FFT) unit 130 and a processing unit 132. The processing unit is as shown in FIG. 1D which processes the time domain sequence with no CP addition.

In another embodiment, the input 120 to the Filter 120 is a time multiplexed sequence, which is one of the symbol structures as shown in the FIGS. 2A, 2C, 2E, 2H, 2L, 2M, 2N. These time multiplexed symbol structures are circular or cyclic in nature. The generated output 134 is fed to the processing unit as shown in FIG. 1D.

FIG. 1D shows a block diagram of a processing unit of the OTFDM symbol generating unit as shown in FIG. 1B, in accordance with another embodiment of the present disclosure. As shown in FIG. 1C, the processing unit 132A comprises a weighted with overlap and add operation (WOLA) unit 146, a bandwidth parts (BWP) specific rotation unit 148, a RF up-conversion unit 150, and a digital to analog converter (DAC).

The processing unit 132A processes the input 140A time domain sequence to generate an OTFDM symbol. The processing comprises performing at least one of a symbol specific phase compensation, up sampling using the up-sampling unit 144, addition of symbol cyclic suffix, windowing, weighted with overlap and add operation (WOLA) using the WOLA unit 146, bandwidth parts (BWP) rotation using BWP specific rotation unit 148, an additional time domain filtering, sampling rate conversion to match DAC rate, frequency shifting on the time domain waveform using RF up conversion unit 150 and converting the same into analog using the DAC 152, to generate the output OTFDM symbol 154A. The generated OTFDM symbol offers low PAPR.

FIG. 1E shows a block diagram illustration of an OTFDM transmitter for generating an OTFDM waveform, in accordance with an alternate embodiment of the present disclosure.

As shown in the FIG. 1E, the transmitter also referred to as a communication system 160 comprises a circular pulse shaping filter with excess bandwidth 162, WOLA unit 164 and a digital to analog converter (DAC) 166. The transmitter 160 also includes a processing unit to process the generated waveform. The transmitter 160 is also referred to as an OTFDM transmitter or an OTFDM symbol generator. In an embodiment, the transmitter 160 also includes a plurality of antennas for transmission of the generated waveforms.

The circular pulse shaping filtering 162 also referred to as pulse shaping filter or circular pulse shaping filtering with excess bandwidth or a shaping filter. The circular pulse shaping filter with excess bandwidth 162 is circular pulse shaping filter is obtained through circular convolution. A linear pulse shaping is obtained through a linear convolution. An OTFDM symbol may be oversampled to a higher rate and convolved with a linear or circular pulse shaping filter. When linear or circular pulse shaping is used, the signal is confined to OTFDM symbol interval. Alternatively, when linear pulse shaping is used, the signal is convolved continuously with a succession of OTFDM symbols, however, the transmitted signal is limited to the duration of the OTFDM symbols.

In an embodiment, the multiplexed symbol (or an input 168 to the transmitter 160) after oversampling is be represented by x′(n), where n=0, 1, . . . , qM−1, where q is the oversampling factor. The oversampling sequence comprises of q−1 zeros inserted after each input sample of the time multiplexed RS and Data sequence. The multiplexed symbol x′(n) or the input 168 may be filtered with circular pulse shaping filter 162 of M.

$${x}_{p s} ( n ) = {x}^{′} ( n ) ⊙ w ( n )$$

The shaping filter 162 is a poly-phase filter using circular convolution operations. The filter w(n) is one of a square root raise cosine, a raised cosine, square root raised cosine, a Hanning, a Blackman, a Hamming window, an oversampled Linearized Gaussian Minimal Shifting Keying (LGMSK) pulse. In an embodiment, the filter 162 w(n) is a square root of the frequency response of the above-mentioned filters. The spectrum shaping filter is either specified by a base station (BS) or unknown at the BS. The spectrum shaping filter may be specified in the standard or specification transparent. The spectrum shaping filter may or may not have zeros at the end, if it has zeros, it may be at the beginning, or at the end, or at the edges. The filtered symbol xₚₛ′(n) is fed to the WOLA unit 164 followed by the DAC 166 to generate an output 170 before transmission. The transmitter 160 excludes either CP addition or CP removal which is performed after IFFT in traditional transmit methods.

In an embodiment, the transmitter 160 performs multiplexing of the data and the RS in one OTFDM symbol, with excess bandwidth and spectrum shaping. The spectrum shaped data is mapped on to the subcarriers allocated to the user, followed by an IFFT of size N to generate an OTFDM waveform. The RS is one of a pi/2-BPSK, a QPSK, a ZC sequences, and an M-PSK sequences. The QPSK, pi/2-BPSK sequences are generated using the binary sequences from Walsh codes, or, m-sequences, Kasami sequences, gold sequences, or may be obtained from the pre-defined sequences, in an embodiment. The generation of said sequences for RS may depend on the cell/sector/Base station ID, scrambling ID, symbol number, sub frame number corresponding to the frame and the numerology. The ZC sequences generation is defined as

$$r ( n ) = {e}^{\frac{jun ( n + 1 + 2 q )}{{N}_{ZC}}} ; n = \{ 0 , 1 , 2 , … … {N}_{ZC} - 1 \}$$

N_{ZC} is the length of the sequence that needs to be generated.

The RS sequence obtained using ZC is a plain ZC sequence or cyclically extended ZC sequence. The frequency spectrum of RS could be flat to ensure unbiased channel estimation. RS and CP for RS can occupy a portion of resources allocated to the user, which may depend on properties of channel conditions, excess bandwidth, user allocation size, modulation order, coding rate, and other parameters like impulse response of spectrum shaping filter.

In an embodiment of the present disclosure, a method for transmitting SS block is provided. The method comprises time-multiplexing, by the transmitter, a PSS OTFDM symbol, a SSS OTFDM symbol and a PBCH OTFDM symbol to generate a multiplexed sequence. Also, the method comprises processing the at least one multiplexed sequence to generate a SS Block. The processing of the at least one multiplexed sequence is performed by the OTFDM generating unit 104 as described and shown in FIG. 1B.

In another embodiment of the present disclosure, a method transmitting OTFDM SS burst is disclosed. The method comprising time-multiplexing a plurality of OTFDM SS Blocks to generate multiplexed OTFDM SS blocks, wherein each of the plurality of OTFDM SS Blocks is associated with a different beam. The multiplexed OTFDM SS blocks are processed by the OTFDM generating unit 104, as described and shown in FIG. 1B, to generate a plurality of OTFDM SS blocks or OTFDM SS Burst. The OTFDM SS burst is transmitted through a predefined number of beams, wherein the multiplexed SS blocks are transmitted in succession one for each beam, said predefined number is one of 1, 8, 16, 32, 64, and 128. The method for transmitting a plurality of OTFDM SS bursts is performed such that two successive OTFDM SS Bursts are time separated by a half frame.

In another embodiment of the present disclosure, a method for transmitting an OTFDM SS burst is provided. The method comprising time-multiplexing a plurality of pre-DFT SS Blocks and guard blocks to generate a time multiplexed block, wherein each of the plurality of pre-DFT SS Blocks comprises a PSS, a SSS and a PBCH, said each of the plurality of pre-DFT SS block is associated with a beam. Each of the guard blocks is a sequence. Thereafter, processing the multiplexed block using OTFDM generation unit to generate OTFDM SS burst. The processing of the at least one multiplexed sequence is performed by the OTFDM generating unit 104 as described and shown in FIG. 1B.

FIGS. 2A-2B shows symbol structure or block of primary synchronization signal (PSS) sequence. As shown in FIG. 2A, the symbol structure comprises a cyclic prefix (CP) and a PSS. The added CP provides circularity to the symbol as shown in FIG. 2A.

FIG. 2B shows the symbol structure which is a PSS sequence. The PSS sequences are at least one of ZC, pi/2 BPSK, QPSK, and M-ary sequences. The pi/2 BPSK, QPSK and M-ary sequences are generated using PN sequences.

The PSS sequence is a function of sector ID or Base station ID. The PSS sequence is one sequence for all sectors or one of N possible sequences, wherein N is an integer. The PSS sequence comprises a base sequence repeated for a predefined number of times, wherein each of the repeated based sequence is multiplied with an element of a code cover sequence.

FIGS. 2C-2D shows symbol structure or block of secondary synchronization signal (SSS) sequence. As shown in FIG. 2C, the symbol structure comprises a cyclic prefix (CP) and an SSS. The added CP provides circularity to the symbol as shown in FIG. 2C. FIG. 2D a symbol structure which is an SSS sequence. The SSS sequence is one of ZC, pi/2 BPSK, QPSK and M-ary sequences. The pi/2 BPSK, QPSK and M-ary sequences are generated using PN sequences. A gNB ID or sector ID is a function of the SSS sequence number along and the PSS ID. In an embodiment, the SSS sequence comprises of a base sequence repeated for a predefined number of times, wherein each of the repeated based sequence is multiplied with an element of a code cover sequence. The predefined number is one of 1, 2, 4 or more.

FIGS. 2E-2H shows various symbol structure with PBCH data and optional PTRS. As shown in FIG. 2E, the symbol is an OTFDM symbol of length M, comprising of PBCH data and RS. The PBCH data may optionally include PT-RS for phase compensation at the receiver. This symbol is circular or cyclic in nature. FIG. 2F shows an OTFDM symbol comprising of data CP, PBCH data plus optional PT-RS, RS CP of length L, RS, PBCH data plus optional PT-RS and data. This RS is also referred to as PBCH-RS. The PT-RS for the phase compensation at the receiver.

The PBCH data is modulated to at least one of pi/2 BPSK, QPSK and M-ary modulation. The pi/2 BPSK, QPSK and M-ary sequences are generated using PN sequences. The PBCH-RS is at least one of pi/2 BPSK, ZC sequence, QPSK and M-ary sequences. The pi/2 BPSK, QPSK and M-ary sequences are generated using PN sequences. The PT-RS is at least one of pi/2 BPSK, QPSK and M-ary sequences. The pi/2 BPSK, QPSK and M-ary sequences are generated using PN sequences. In an embodiment, the PBCH sequence comprises one of a PBCH CP and a PBCH CP along with PBCH CS.

The PBCH-RS sequence comprises a base sequence repeated for a predefined number of times, wherein each of the repeated based sequence is multiplied with an element of a code cover sequence. The predefined number is one of 1, 2, 4 or more. The PBCH-RS is a function of at least one of a cell ID or physical cell ID, a sector ID, a Base station ID, a half frame index and a SSB index.

FIG. 2G shows an OTFDM symbol comprising of RS cyclic prefix (CP) of length L, PBCH data and optional PT-RS and RS. The optionally include PT-RS is for the phase compensation at the receiver. As shown in FIG. 2H, the symbol is a cyclic OTFDM symbol comprising of PBCH data, RS CP, RS, and PBCH data. The PBCH data may optionally include PT-RS for phase compensation at the receiver

FIG. 2I shows an illustration of different OTFDM Symbol carrying SSB, in accordance with an embodiment of the present disclosure.

The SS Block OTFDM symbol is one of a PSS OTFDM symbol comprising of only PSS sequence, a SSS OTFDM symbol comprising of only SSS sequence, a PBCH OTFDM symbol comprising of only PBCH, and OTFDM symbol comprising of PSS sequence, SSS sequence, PBCH. In an embodiment, length of the PSS sequence, the SSS sequence and the PBCH are same or different.

The PSS sequence includes one of a PSS cyclic prefix (CP), and a PSS CP along with a PSS cyclic suffix (CS). The SSS sequence includes one of a SSS CP and a SSS CP along with a SSS CS. The PBCH comprises at least one of a PBCH data and a PBCH data CP. In an embodiment, the PSS sequence and SSS sequence may not include CP or CS.

FIG. 2J shows an example illustration of a PSS sequence which is a pre-DFT sequence, where PSS base sequence is repeated N times to generate an OTFDM symbol in time. FIG. 2K shows an example illustration of a SSS sequence which is a pre-DFT sequence, where SSS base sequence is repeated N times to generate an OTFDM symbol in time.

FIG. 2L shows an illustration of a SS Block, in accordance with an embodiment of the present disclosure. The SS Block is a multiplexed sequence comprising at least one of a primary synchronization signal (PSS) sequence, a secondary synchronization signal (SSS) sequence, a physical broadcast channel (PBCH) sequence, and a portion of the at least one of PSS sequence, SSS sequence and PBCH sequence.

In an embodiment, the shaded portion is a portion from PSS sequence. In another embodiment, the shaded portion may be a portion from PBCH sequence.

As shown in the FIG. 2L, the shaded portion at the beginning of the symbol structure is a portion from PBCH sequence and the shaded portion at the end of the symbol structure is a portion from PSS sequence.

The shaded portion at the beginning of the symbol is referred as first shaded portion. The shaded portion at the end of the symbol is referred as second shaded portion. In an embodiment, the first shaded portion and second shaded portion is a combination of portions from at least one of PSS sequence, SSS sequence and PBCH.

In an embodiment, the symbol includes only first shaded portion along with the PSS sequence, SSS sequence and PBCH, where the first shaded portion is from PBCH sequence. In another embodiment, the symbol includes only first shaded portion along with the PSS sequence, PBCH, SSS sequence, where the first shaded portion is from SSS sequence. In another embodiment, the symbol includes only first shaded portion along with the SSS sequence, PBCH and PSS sequence, where the first shaded portion is from PSS sequence.

In an embodiment, the symbol includes only second shaded portion along with the PSS sequence, SSS sequence and PBCH, where the second shaded portion is from PSS sequence. In another embodiment, the symbol includes only second shaded portion along with the SSS sequence, PSS sequence, PBCH, where the second shaded portion is from SSS sequence. In another embodiment, the symbol includes only second shaded portion along with the PBCH, PSS sequence, and SSS sequence, where the second shaded portion is from PBCH sequence.

In another embodiment, some part of the shaded portion is from SSS sequence and remaining part of the shaded portion is from PBCH sequence. In yet another embodiment, some part of the shaded portion is from PSS sequence and another part of the shaded portion is from SSS sequence. In yet another embodiment, some part of the shaded portion is from PSS sequence, another part of the shaded portion is from SSS sequence, and yet another part is from PBCH sequence.

FIG. 2M shows an illustration of a SS Block, in accordance with another embodiment of the present disclosure. The SS Block is a multiplexed sequence comprising at least one of a PSS sequence, a SSS sequence, a PBCH sequence, a PBCH RS, and a portion of the at least one of the PSS sequence, the SSS sequence, the PBCH sequence, the PBCH RS. The time multiplexed sequence of symbol structure is cyclic.

FIG. 2N shows an illustration of a SS Block, in accordance with another embodiment of the present disclosure. The SS Block is a multiplexed sequence comprising at least one of a PSS CP, a PSS sequence, a PSS CS, a SSS CP, a SSS sequence, a SSS CS, a PBCH CP, a PBCH sequence, a PBCH CS and a portion of the at least one of a PSS CP, a PSS sequence, a PSS CS, a SSS CP, a SSS sequence, a SSS CS, a PBCH CP, a PBCH sequence, a PBCH CS. In an embodiment, the shaded portion is a portion of the at least one of PSS sequence, SSS sequence and PBCH sequence.

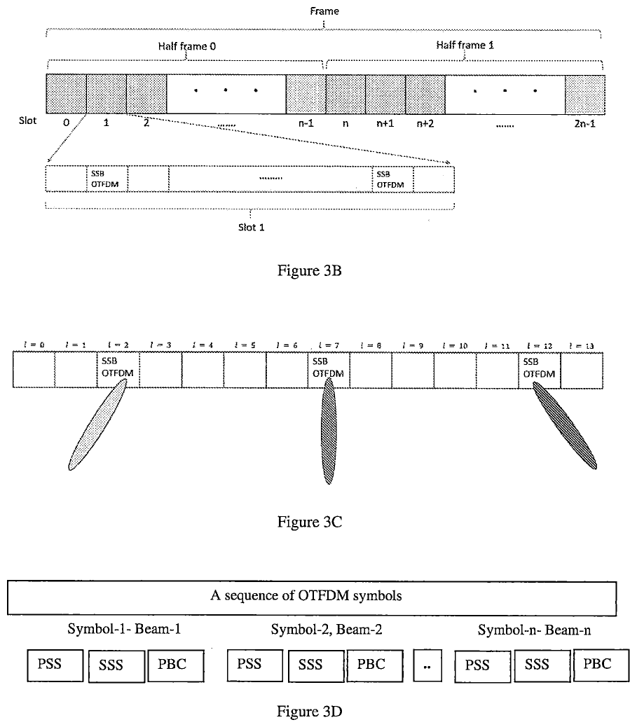

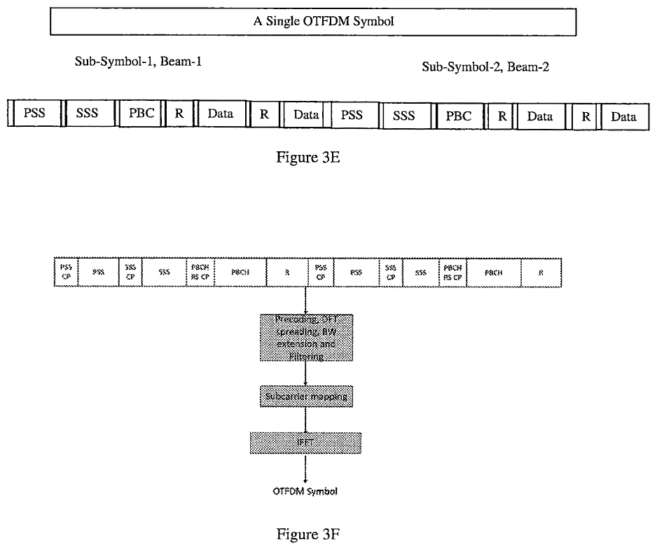

FIG. 3A shows an illustration of PSS, SSS, PBCH carried in one OTFDM SSB symbol, in accordance with an embodiment of the present disclosure.

FIG. 3A is showing different steps involved in the generation of the above explained time multiplexed filtered-extended bandwidth single symbol. As shown in the FIG. 3A, CP is added to PSS, SSS and PBCH. As part of CP and CS addition, after DFT spreading of the data, the bandwidth of the signal is extended and this extended bandwidth signal is used for OTFDM generation by passing it through the IFFT. This method is without CP addition. Also, the input symbol structure shown in FIG. 3A is as an illustration. The input is at least one of the symbol structures shown in the FIGS. 2A, 2C, 2E, 2H, 2L, 2M, 2N. These time multiplexed symbol structures are circular or cyclic in nature.

In another embodiment, as shown in the FIG. 3A the PSS, SSS and PBCH, after DFT spreading of the data, the bandwidth of the signal is extended and this extended bandwidth signal is used for OTFDM generation by passing it through the IFFT and CP addition modules. In an embodiment, the input is one of the symbol structures shown in the FIGS. 2B, 2D, 2F, 2G, 2I.

FIG. 3B shows an illustration of multiple SS block OTFDM symbols in a slot. The pattern of SS block OTFDM symbol positions in time within a half frame repeats itself with a periodicity of a half frame.

The FIG. 3B illustrates the transmission of SS burst, where multiple OTFDM SS block symbols are transmitted in a half frame. Different SS blocks associated with different beams are occupying different symbols in a slot. A maximum of Lmax SS blocks are transmitted in a half frame, where Lmax defines the maximum number of the beams having unique beam IDs. The periodicity of the SS burst transmission can be a half frame, a frame, two frames etc. In the example figure, it is showing the periodicity of SS burst transmission as a half frame. The candidate OTFDM SS block symbols in a half frame are indexed in an ascending order in time from 0 to Lmax−1. In the FIG. 3A, 2n slots are there in a frame. The slots in the frame are numbered from 0 to 2n−1 in ascending order in time.

FIG. 3C shows an illustration of multiple SS block OTFDM symbols in a slot associated with different beams. As shown in FIG. 3C, the transmission of different OTFDM SS block symbols in time, having different beam IDs, associated with different beams in different directions is provided. To construct a beam in a specific direction, the SS block OTFDM symbol as shown in the FIG. 3C is precoded by multiplying with antenna port weight factors and transmitted over the antenna ports.

One embodiment of the present disclosure is Beam sweeping system. FIG. 3D shows a beam sweeping over successive OTFDM symbols, in a downlink transmitter. As shown in FIG. 3D, a beam sweeping is performed over successive OTFDM symbols. As shown in FIG. 3D, the synchronization channel structure in the beam sweeping systems where each symbol undergoes transmission in a specific beam. A synchronization comprising of PSS, SSS, PBCH is transmitted in one symbol dedicated to one beam number. In an embodiment, the OTFDM symbols are generated using the time multiplexing of the PSS, SSS, PBCH to generate the symbols structures as shown in FIGS. 2A, 2C, 2E, 2H, 2L, 2M, 2N, which are circular. These multiplexed symbol structures are fed to the filter 120, for the OTFDM waveform generation, and there is no requirement of CP addition post IFFT. In another embodiment, the OTFDM symbols are generated using the time multiplexing of the PSS, SSS, PBCH to generate the symbols structures as shown in FIGS. 2B, 2D, 2F, 2G, 2I. These multiplexed symbols may not be circular. These multiplexed symbol structures are fed to the filter 120, for the OTFDM waveform generation. The same sequence may be transmitted in successive symbols or the sequence may be function of one or more combinations of: OTFDM symbol number, and cell ID or sector ID or beam ID.

FIG. 3E shows a beam sweeping in a single OTFDM symbol, in a downlink transmitter. As shown in FIG. 3E, the synchronization channel structure is for beam sweeping systems where a symbol is divided into multiple symbols and each sub-symbol undergoes transmission in a specific beam. A synchronization comprising of PSS, SSS, PBCH is transmitted in one sub-symbol dedicated to one beam number. The same RS sequence may be transmitted in successive sub-symbols or the sequence may be function of one or more combinations of OTFDM sub-symbol number, and cell ID or sector ID or beam ID. In an embodiment, the OTFDM symbols are generated using the time multiplexing of the PSS, SSS, PBCH to generate the symbols structures as shown in FIGS. 2A, 2C, 2E, 2H, 2L, 2M, 2N, which are circular. These multiplexed symbol structures are fed to the filter 120, for the OTFDM waveform generation, and there is no requirement of CP addition post IFFT. In another embodiment, the OTFDM symbols are generated using the time multiplexing of the PSS, SSS, PBCH to generate the symbols structures as shown in FIGS. 2B, 2D, 2F, 2G, 2I. These multiplexed symbols may not be circular. These multiplexed symbol structures are fed to the filter 120, for the OTFDM waveform generation.

FIG. 3F shows an illustration of generation of an OTFDM symbol where two SS blocks are time multiplexed and each SS block is associated with a different beam. It illustrates the case where multiple SS blocks are transmitted over the same OTFDM symbol in time. Two pre DFT SS blocks having PSS, SSS and PBCH sequences are placed along with some guard sequence R in between. These SS blocks are one of the symbol structures as shown in FIGS. 2A, 2C, 2E, 2H, 2L, 2M, 2N. The figure shown for an example illustration only. The inputs symbol structures may be altered. Thus, arranged sequence is then passed through precoder, DFT spread and BW extension and filtering module to generate a filtered bandwidth extended signal. This signal is then subcarrier mapped and IFFT is performed on it to generate an OTFDM symbol.

In another embodiment, two pre DFT SS blocks having PSS, SSS and PBCH sequences are placed along with some guard sequence R in between and the symbol structures used are one of the symbol structures as shown in FIGS. 2B, 2D, 2F, 2G, 2I. Thus, arranged sequence is then passed through precoder, DFT spread and BW extension and filtering module to generate a filtered bandwidth extended signal. This signal is then subcarrier mapped, IFFT and CP addition is performed on it to generate an OTFDM symbol.

In another embodiment, the generation of an OTFDM symbol where two SS blocks are time multiplexed and each SS block is associated with a different beam. The multiple SS blocks are transmitted over the same OTFDM symbol in time. Two pre DFT SS blocks having PSS, SSS and PBCH sequences are placed along with some guard sequence R in between. The thus arranged sequence is then passed through precoder, DFT spread and BW extension and filtering module to generate a filtered bandwidth extended signal. This signal is then subcarrier mapped followed by IFFT to generate an OTFDM symbol. The symbol structures used are at least one of the symbols as shown in 2A, 2C, 2E, 2H, 2L, 2M, 2N.

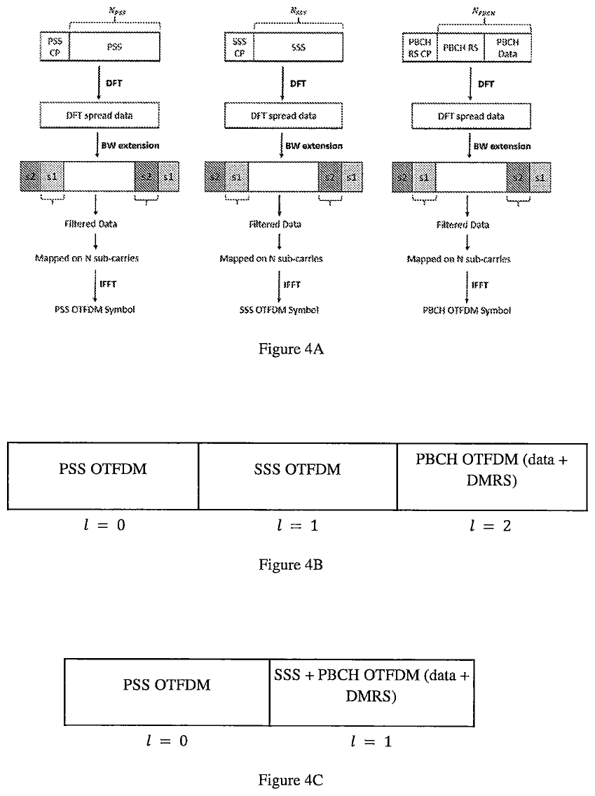

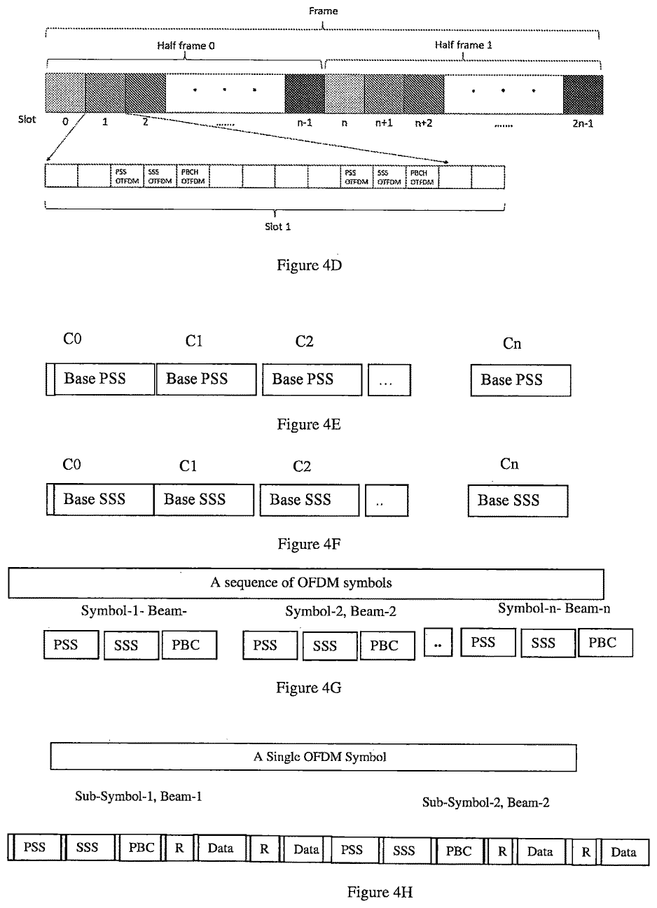

FIG. 4A shown an illustration of generation of PSS OTFDM symbol, SSS OTFDM symbol and PBCH OTFDM symbol. The input symbol structures as shown in the FIG. 4A is only for illustration purpose, and these input symbol structures may be modified using other symbol structures described in this present disclosure. The input multiplexed sequence or symbol structure is any one of the symbol structures as shown and described in FIGS. 2A, 2C, 2E, 2H, 2L, 2M, 2N. These input symbols are circular or cyclic. The input symbol structures as shown in the FIG. 4A is for an illustration.

As shown in FIG. 4A, the input sequences are processed using DFT, DFT spreaded followed by filtering, mapping, IFFT to generate OTFDM symbol. The PDCH data may optionally include PT-RS for phase compensation at the receiver. This symbol is cyclic in nature. As shown in FIG. 4A, the input multiplexed symbol is an OTFDM symbol comprising of at least one of 1st input symbol i.e. PSS CP and PSS, 2nd input symbol is SSS CP, SSS and 3rd input symbol is PBCH RS CP, PBCH RS and PBCH data. The PDCCH data may optionally include PT-RS for phase compensation at the receiver.

In another embodiment, the input symbol structures of FIG. 4A are one of the symbol structures as shown and described in FIGS. 2B, 2D, 2F, 2G, 2I. As shown in FIG. 4A, the input sequences are processed using DFT, DFT spreaded followed by filtering, mapping and IFFT and CP addition to generate OTFDM symbol. The input symbols may not be cyclic. The PBCH data may optionally include PT-RS for phase compensation at the receiver. As shown in FIG. 4A, the symbol is an OTFDM symbol comprising of 1st symbol as PSS, 2nd symbol as SSS, and 3rd symbol as PBCH RS CP, PBCH RS, and PBCH data. The PBCH data may optionally include PT-RS for phase compensation at the receiver.

FIG. 4B shows an illustration of an SS block consisting of 3 OTFDM symbols in time. As shown in the FIG. 4B, the SS block comprises 1st symbol as PSS OTFDM symbol which is generated using the filter or OTFDM symbol generating unit 104, when the input multiplexed sequence comprises only PSS sequence. The SS block comprises 2nd symbol which is SSS OTFDM symbol and 3rd symbol is PBCH OTFDM symbol. The SS OTFDM symbol is generated using the OTFDM symbol generating unit 104, when the input multiplexed sequence comprises only SSS sequence. Similarly, the PBCH OTFDM symbol is generated using the OTFDM symbol generating unit 104, when the input multiplexed sequence comprises only PBCH. The PBCH comprises a PBCH data and DMRS.

FIG. 4C shows an illustration SS block consisting of 2 OTFDM symbols in time. As shown in the FIG. 4C, the SS block comprises 1st symbol as PSS OTFDM symbol which is generated using the filter or OTFDM symbol generating unit 104, when the input multiplexed sequence comprises only PSS sequence. The SS block comprises 2nd symbol which is SSS+PBCH OTFDM symbol, which is generated using the OTFDM symbol generating unit 104, when the input multiplexed sequence comprises SSS sequence and PBCH. The PBCH comprises a PBCH data and DMRS.

FIG. 4D illustrates the transmission of SS burst, where multiple SS blocks are transmitted in a half frame. Each SS block consists of PSS OTFDM, SSS OTFDM and PBCH OTFDM symbol.

Each SS block is at least one symbol, wherein one symbol consists of PSS, SSS and PBCH; or two symbols with 1st symbol carrying PSS and 2nd symbol carrying SSS and PBCH; In another embodiment, the SS block with two symbols comprises 1st symbol carrying PSS and SSS, and 2nd symbol carrying PBCH; three symbols wherein 1st symbol carrying PSS, 2nd symbol carrying SSS and last symbol carrying PBCH.

Different SS blocks associated with different beams are occupying different symbols in a slot. A maximum of Lmax SS blocks are transmitted in a half frame, where Lmax defines the maximum number of the beams having unique beam IDs. In the example figure, the SS burst transmission periodicity is a half frame. The candidate SS blocks in a half frame are indexed in an ascending order in time from 0 to Lmax−1. In the figure, 2n slots are there in a frame. The slots in the frame are numbered from 0 to 2n−1 in ascending order in time.

FIG. 4E shows an illustration of PSS symbol. The sequences for instance can be a single base sequence (with one of CP and CS), or multiple sequences repeated together (repeated sequences may not include CP and/or CS). An additional code cover may be applied on the base PSS sequence. The base sequence is one of pi/2 BPSK and ZC sequences. The base sequence may be single sequence, or it may be sector specific sequence.

FIG. 4F shows an illustration of SSS symbol. The sequences for instance can be a single base sequence (with one of CP and CS), or multiple sequences repeated together (repeated sequences may not include CP and/or CS). An additional code cover may be applied on the base SSS sequence. The base sequence is one of pi/2 BPSK and ZC sequences. In another embodiment, instead of repeating the base sequence, a long SSS based on pi/2 BPSK or ZC sequences may be used.

One embodiment of the present disclosure is Beam sweeping system. FIG. 4G shows a beam sweeping over successive OTFDM symbols. As shown in FIG. 4G, the sync channel structure in the beam sweeping systems where each symbol undergoes transmission in a specific beam. A sync comprising of PSS, SSS, PBCH is transmitted in one symbol dedicated to one beam number. The same RS sequence may be transmitted in successive symbols or the sequence may be function of one or more combinations of: OTFDM symbol number, and cell ID or sector ID or beam ID.

FIG. 4H shows a synchronization channel structure in a beam sweeping systems where a symbol is divided into multiple symbols and each sub-symbol undergoes transmission in a specific beam. A sync comprising of PSS, SSS, PBCH is transmitted in one sub-symbol dedicated to one beam number. The same RS sequence may be transmitted in successive sub-symbols or the sequence may be function of one or more combinations of: OTFDM sub-symbol number, and cell ID or sector ID or beam ID.

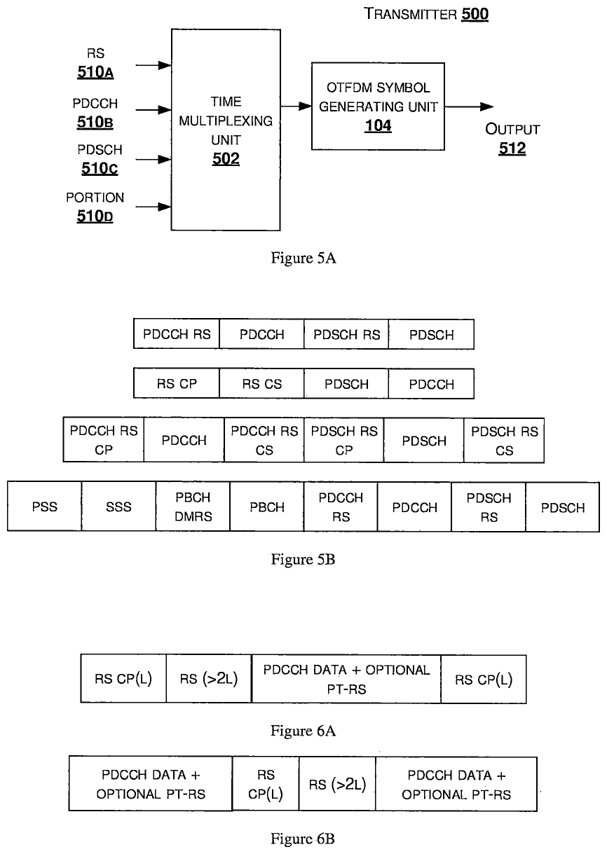

FIG. 5A shows a block diagram of an OTFDM transmitter, in accordance with another embodiment of the present disclosure. The OTFDM transmitter 500 is referred to as a transmitter or a communication system.

As shown in the FIG. 5A, the transmitter 500 comprises a time multiplexing unit 502 and an OTFDM symbol generating unit 104. The time multiplexing unit 502 is also referred as a time multiplexer or multiplexer or time division multiplexer or TDM. Also, the transmitter 500 comprises a plurality of antennas. The OTFDM symbol generating unit 104 is also referred as OTFDM symbol generator or symbol generator which is as shown in FIG. 1B.

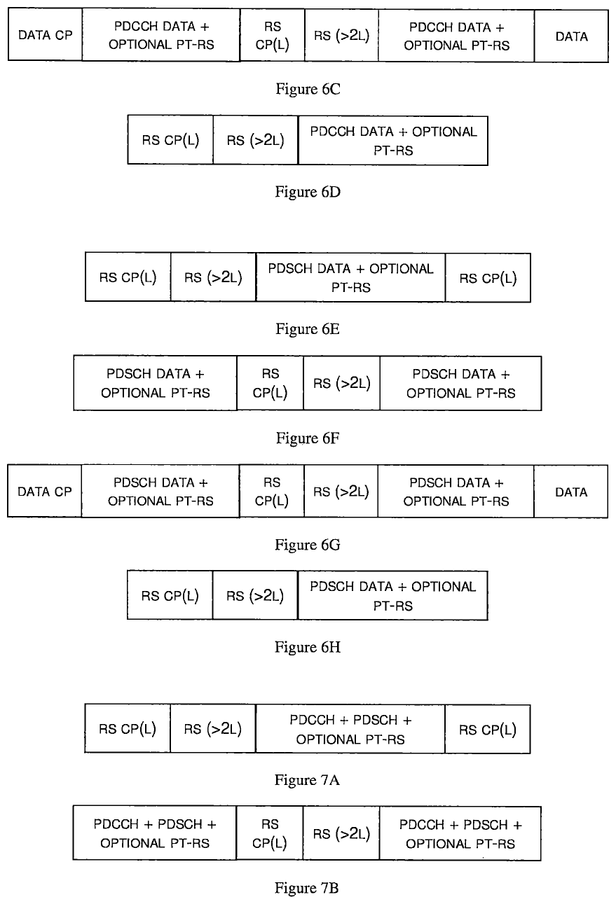

In an embodiment, the time multiplexer 502 multiplexes a reference sequence (RS) 510A, a control data sequence (mapped on to PDCCH) 510B, user data sequence (mapped on to PDSCH) 510C and a portion of at least one of the RS, the control data sequence, the user data sequence to generate a multiplexed sequence. The multiplexed sequence is also referred to as time multiplexed sequence or TDM sequence or pre-DFT symbols. The symbols shown in FIGS. 6A, 6B, 6E, 6F, 7A, 7B, 8A, 8B, 8C, 8D, 8E are the multiplexed sequences obtained using time multiplexer 502, said symbols are circular.

The OTFDM symbol generating unit 104, which is as shown in FIG. 1B, generates an output 512 called as OTFDM symbol using the multiplexed sequences. As the multiplexed sequence is obtained using the control data sequence (mapped on to PDCCH) 510B, the user data sequence (mapped on to PDSCH) 510C and the RS, the generated symbol is referred as PDCCH-PDSCH Orthogonal time frequency-division multiplexing (OTFDM) symbol or PDCCH-PDSCH OTFDM symbol. The multiplexed sequence is fed to the OTFDM symbol generating unit 104 as shown in FIG. 1B and the output 134 is fed to the processing unit of FIG. 1D to generate a OTFDM symbol. In an embodiment, the generated OTFDM symbols are specific to a particular antenna. The symbol generated is transmitted by one of a specific antenna from the plurality of antennas.

In another embodiment, the time multiplexer 502 multiplexes a reference sequence (RS) 510A, a control data sequence (mapped on to PDCCH) 510B, user data sequence (mapped on to PDSCH) 510C to generate a multiplexed sequence. The symbol structures as shown in the FIGS. 5B, 6C, 6D, 6G, 6H, 7C, 7D, 7E, 7F are the multiplexed sequences used in this embodiment. The multiplexed sequence is fed to the OTFDM symbol generating unit 104 as shown in FIG. 1B and the output 134 is fed to the processing unit of FIG. 1C to generate a OTFDM symbol. In an embodiment, the generated OTFDM symbols are specific to a particular antenna. The symbol generated is transmitted by one of a specific antenna from the plurality of antennas.

In another embodiment, the generated OTFDM waveform undergoes a procedure known as Antenna precoding, where the purpose of precoding is to map the generated OTFDM symbols to a set of antenna ports using a precoder matrix. The generated OTFDM signal is multiplied using antenna port specific phase weights and each weighted signal is transmitted using an antenna port. Each complex weighted baseband OTFDM signal is converted to analog waveform using digital to analog converter (DAC). The analog OTFDM waveform undergoes power amplification to boost the signal strength to a level capable of transmission across the air interface. Since, OTFDM signal has low PAPR, the PA requires low back off, thereby resulting in energy efficient transmission. For pi/2 BPSK OTFDM the back off may be 0 dB or very low value so that signal can be transmitted close to power amplifier (PA) saturation power. Digital pre distortion operation may be used before PA when higher order modulation is used. Further the OTFDM waveform undergoes radio frequency (RF) filtering subsequently transmitted through the antenna array.

In an embodiment, the duration of the PDCCH sequence and the PDSCH sequences is unequal. The PDCCH carries a common control information and a user specific control information. The PDSCH carries a user specific data. The RS is used to demodulate the PDCCH and PDSCH by one or more receiving users. FIG. 5B shows an illustration of different OTFDM Symbol carrying downlink channels.

The PDCCH RS is at least one of ZC, pi/2 BPSK, QPSK, and M-ary sequences. The pi/2 BPSK, QPSK and M-ary sequences are generated using PN sequences.

The PDCCH RS is a function of at least one of a symbol ID, slot number, cell ID or physical cell ID, scrambling ID. In an embodiment, the PDCCH RS is one of user specific sequence. In an embodiment, the PDCCH RS is not a user specific sequence. In an embodiment, user specific PDCCH RS is generated by applying an Orthogonal cover code on the base sequence, where base sequence is one of ZC, pi/2 BPSK, QPSK, and M-ary sequences

PDCCH data sequence is one of pi/2 BPSK, QPSK and M-ary sequences. The data sequence is spectrum shaped when it is pi/2 BPSK.

The generated OTFDM symbol is a PDCCH OTFDM symbol, when the input to the time multiplexing unit 502 is PDCCH/control information only. In an embodiment, the generated PDCCH OTFDM symbol may be repeated N number of times, where N is natural number.

The generated OTFDM symbol is a PDSCH OTFDM symbol, when the input to the time multiplexing unit 502 is PDSCH/user specific data only.

The PDSCH RS is one of ZC, pi/2 BPSK, QPSK, and M-ary sequences. The pi/2 BPSK, QPSK and M-ary sequences are generated using PN sequences. The PDSCH RS is a function of at least one of a symbol ID, slot number, cell ID or physical cell ID, scrambling ID. In an embodiment, user specific PDSCH RS is generated by applying an Orthogonal cover code on the base sequence, where base sequence is one of ZC, pi/2 BPSK, QPSK, and M-ary sequences

The PDSCH user data sequence is one of pi/2 BPSK, QPSK and M-ary sequences. The user data sequence is spectrum shaped when it is pi/2 BPSK.

FIG. 6A shows various symbol structure with PDCCH data and optional PTRS with RS. The symbol is an OTFDM symbol of length M, comprising of PDCCH data and RS.

As shown in FIG. 6A, the symbol is an OTFDM symbol of length M, comprising of PDCCH data, RS and RS cyclic prefix (CP) at the start and end of the symbol. The PDCH data may optionally include PT-RS for phase compensation at the receiver. This symbol is cyclic in nature. As shown in FIG. 6A, the symbol is an OTFDM symbol comprising of data, PDCCH data, RS CP, RS, PDCCH data and data. The PDCCH data may optionally include PT-RS for phase compensation at the receiver.

The FIG. 6B shows a symbol structure of PDCCH data, in accordance with an embodiment. As shown in FIG. 6B the OTFDM symbol comprising of PDCCH data and optional PT-RS, RS cyclic prefix (CP), RS, and PDCCH data and optional PT-RS. The RS CP is of length L, and RS is greater than length 2L, where L in an integer. Also, the OTFDM symbol is a circular or cyclic. The PDCCH data may optionally include PT-RS for phase compensation at the receiver.

FIG. 6C shows a symbol structure with PDCCH data and optional PTRS, the symbol is an OTFDM symbol comprising of data CP, PDCCH data plus optional PT-RS, RS CP, RS, and data. The PDCCH data may optionally include PT-RS for phase compensation at the receiver.

FIG. 6D shows a symbol structure with PDCCH data and optional PTRS, in accordance with an embodiment of the present disclosure. As shown in FIG. 6D shows the OTFDM symbol comprising of RS cyclic prefix (CP) of length L, RS and PDCCH data and optional PT-RS. The optionally include PT-RS is for the phase compensation at the receiver.

FIGS. 6E-6H shows various symbol structure with PDSCH data and optional PTRS. The data may optionally include PT-RS for phase compensation at the receiver.

As shown in FIG. 6E, the symbol is of length M, comprising of a RS cyclic prefix (CP) at the start and end of the symbol, a PDSCH data and a RS. The PDSCH data may optionally include PT-RS for phase compensation at the receiver. This symbol is circular or cyclic in nature.

As shown in FIG. 6F, the symbol is a cyclic symbol comprising of a PDSCH data, a RS CP, a RS and a PDSCH data. The PDSCH data may optionally include PT-RS for phase compensation at the receiver.

As shown in FIG. 6G, the symbol comprises a data CP, a PDSCH data, RS CP, RS, PDSCH data and a data. The PDSCH data may optionally include PT-RS for phase compensation at the receiver.

The FIG. 6H shows an OTFDM symbol comprising of RS cyclic prefix (CP) of length L, a RS and PDSCH data. The PDSCH data optionally include PT-RS is for the phase compensation at the receiver.

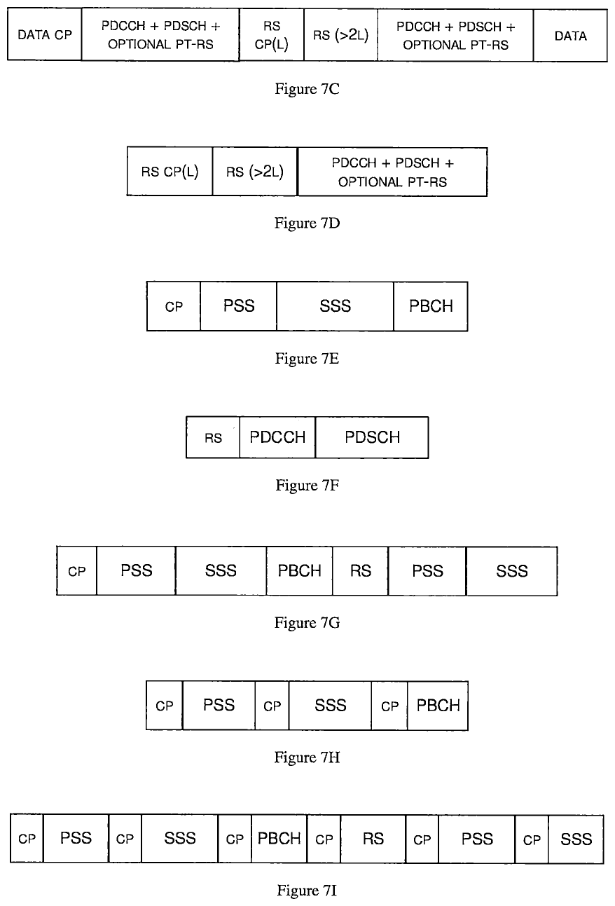

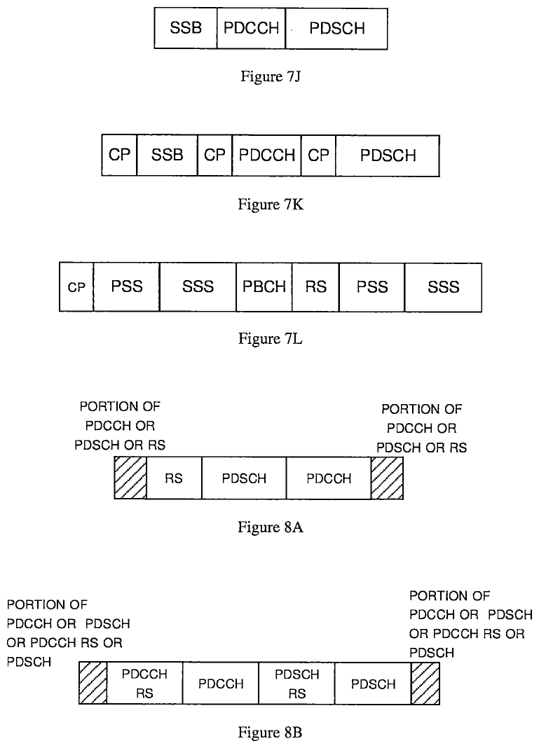

FIGS. 7A-7D shows various symbol structure with PDCCH plus PDSCH data and optional PTRS. As shown in FIG. 7A, the symbol is of length M, comprising RS cyclic prefix (CP) at the start and end of the symbol, a RS, and PDCCH plus PDSCH data. The PDSCH data may optionally include PT-RS for phase compensation at the receiver. This symbol is cyclic in nature. As shown in FIG. 7B, the symbol is a cyclic comprising PDCCH plus PDSCH data, RS CP, RS and PDCCH plus PDSCH data. The PDSCH data may optionally include PT-RS for phase compensation at the receiver.

FIG. 7C shows a symbol comprising of a data CP, a PDCCH plus PDSCH data, a RS CP, a RS, PDCCH plus PDSCH data and a data. The PDSCH data may optionally include PT-RS for phase compensation at the receiver. The FIG. 7D shows a symbol comprising of RS cyclic prefix (CP) of length L, a RS and PDCCH plus PDSCH data and optional PT-RS. The optional PT-RS is used for the phase compensation at the receiver.

FIGS. 7E-7H shows various symbol structure of PSS, SSS, PBCH, PDCCH and PDSCH data. In an embodiment, the symbol of as shown in FIG. 7E is an OTFDM symbol. The symbol comprising CP, PSS, SSS and PBCH. FIG. 7F shows a symbol comprising RS, PDCCH and PDSCH.

The symbol as shown in FIG. 7G comprising CP, PSS, SSS, PBCH, RS, PDCCH and PDSCH. As shown in FIG. 7H, the symbol comprising PSS-CP, PSS, SSS-CP SSS and PBCH-CP, and PBCH. In another embodiment, the symbol comprising CP for the block as shown in FIG. 7H. That is the symbol comprises CP, PSS-CP, PSS, SSS-CP SSS and PBCH-CP, and PBCH.

As shown in FIG. 7L, the symbol comprising PSS-CP, PSS, SSS-CP, SSS, PBCH-CP, PBCH, RS-CP, RS, PDCCH-CP, PDCCH, PDSCH-CP, and PDSCH. In another embodiment, the symbol comprising CP for the block as shown in FIG. 7L. That is the symbol comprises CP, PSS-CP, PSS, SSS-CP, SSS, PBCH-CP, PBCH, RS-CP, RS, PDCCH-CP, PDCCH, PDSCH-CP, and PDSCH.

FIGS. 7J-7L shows various symbol structure of SSB, PDCCH and PDSCH, PSS and SSS channel data. FIG. 7J shows an OTFDM symbol in an embodiment. The symbol comprises SSB, PDCCH and PDSCH. FIG. 7K shows a symbol comprising SSB-CP, SSB, PDCCH-CP, PDCCH, PDSCH-CP and PDSCH. In another embodiment, the symbol comprising CP for the block as shown in FIG. 7K. That is the symbol comprises CP, SSB-CP, SSB, PDCCH-CP, PDCCH, PDSCH-CP and PDSCH. FIG. 7L shows a symbol structure comprising CP, PSS, SSS, PBCH, RS, PSS, SSS.

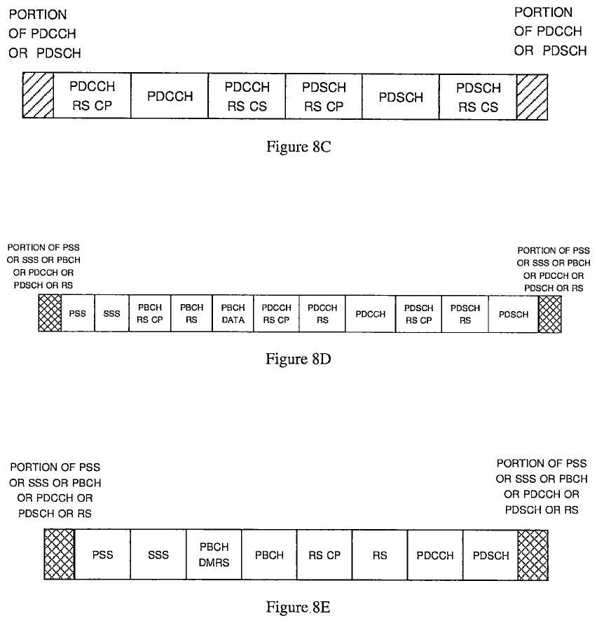

FIGS. 8A-8C shows various symbol structure of RS, PDCCH, PDSCH channel data, in accordance with some embodiments of the present disclosure. The symbols shown in these FIG. 8A-8C are circular or cyclic. As shown in the FIG. 8A, the symbol comprises a shaded portion at the beginning and end of the symbol, a reference sequence (RS), a user data sequence (mapped on to PDSCH), a control data sequence (mapped on to PDCCH). The portion is at least one of the RS, the control data sequence, the user data sequence.

The symbol as shown in FIG. 8B, the symbol comprises a PDCCH RS, control data sequence (mapped on to PDCCH), a PDSCH RS, a user data sequence (mapped on to PDSCH), and portion at the beginning and end of the symbol. The portion is at least one of a portion of PDCCH RS, portion of control data sequence, a portion of PDSCH RS, and a portion of user data sequence.

The symbol as shown in FIG. 8C, the symbol comprises a PDCCH RS CP, a control data sequence (mapped on to PDCCH), a PDCCH RS CS, a PDSCH RS CP, a user data sequence (mapped on to PDSCH), a PDSCH RS CS, and portion at the beginning and end of the symbol. The portion is at least one of a portion of a PDCCH RS CP, portion of a control data sequence, a portion of PDCCH RS CS, a portion of PDSCH RS CP, a portion of user data sequence, and a portion of PDSCH RS CS.

FIGS. 8D-8E shows various symbol structure of SSB, PDCCH and PDSCH, PSS and SSS channel data, in accordance with another embodiment of the present disclosure.

As shown in FIG. 8D, the symbol comprises a PSS, a SSS, a PCH RS CP, a PBCH RS, a PBCH data, a PDCCH RS CP, a control data sequence (mapped on to PDCCH) or PDCCH, PDCCH RS, a PDSCH RS CP, a PDSCH RS, a user data sequence (mapped on to PDSCH) or PDSCH, and a portion of at least one of the PSS, the SSS, the PCH RS CP, the PBCH RS, the PBCH data, the PDCCH RS CP, the PDCCH, the PDCCH RS, the PDSCH RS CP, the PDSCH RS and the PDSCH.

As shown in FIG. 8E, comprises a PSS, a SSS, a PCH DMRS, a PBCH, a RS CP, a RS, a control data sequence (mapped on to PDCCH) or PDCCH, a user data sequence (mapped on to PDSCH) or PDSCH, and a portion of at least one of the PSS, the SSS, the PCH DMRS, the RS CP, the RS, the PDCCH and the PDSCH.

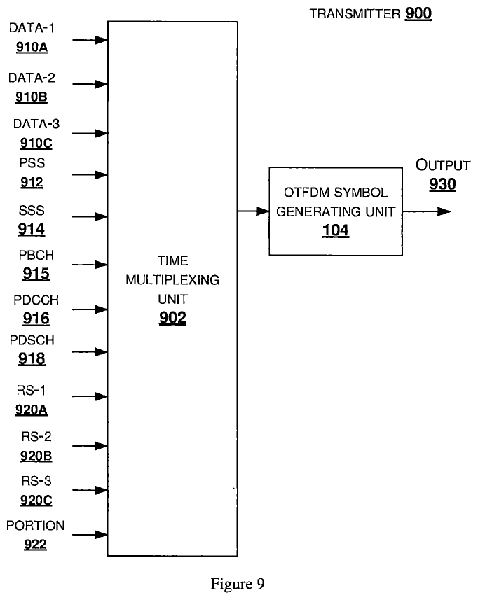

FIG. 9 shows a block diagram of an OTFDM transmitter, in accordance with another embodiment of the present disclosure. The OTFDM transmitter 900 is referred to as a transmitter or a communication system.

As shown in the FIG. 9, the transmitter 900 comprises a time multiplexing unit 902 and an OTFDM symbol generating unit 104. The time multiplexing unit 902 is also referred as a time multiplexer or multiplexer or time division multiplexer or TDM. Also, the transmitter 900 comprises a plurality of antennas. The OTFDM symbol generating unit 104 is also referred as OTFDM symbol generator or symbol generator which is as shown in FIG. 1B.

In an embodiment, the time multiplexer 902 multiplexes a plurality of data (910A, 910B, 910C), PSS sequence (912), SSS sequence (914), PBCH sequence (915), a control data sequence (mapped on to PDCCH) (916), user data sequence (mapped on to PDSCH) (918), a plurality of reference sequence (RS) (920A, 920B, 920C) and a portion of at least one of the plurality of data, PSS, SSS, PBCH, the plurality of RS, the control data sequence, and the user data sequence, to generate a multiplexed sequence. The multiplexed sequence is also referred to as time multiplexed sequence or TDM sequence or pre-DFT symbols. The multiplexed symbols generated may be one of the symbol structures shown in FIGS. 6A, 6B, 6E, 6F, 7A, 7B, 8A, 8B, 8C, 8D, 8E, which are circular.

The OTFDM symbol generating unit 104, which is as shown in FIG. 1B, generates an output 930 called as OTFDM symbol using the multiplexed sequences. The multiplexed sequence is fed to the OTFDM symbol generating unit 104 as shown in FIG. 1B and the output 134 is fed to the processing unit of FIG. 1D to generate a OTFDM symbol. In an embodiment, the generated OTFDM symbols are specific to a particular antenna. The symbol generated is transmitted by one of a specific antenna from the plurality of antennas.

In another embodiment, the time multiplexer 902 multiplexes a plurality of data (910A, 910B, 910C), PSS sequence (912), SSS sequence (914), PBCH sequence (915), a control data sequence (mapped on to PDCCH) (916), user data sequence (mapped on to PDSCH) (918), a plurality of reference sequence (RS) (920A, 920B, 920C) and a portion of at least one of the plurality of data, PSS, SSS, PBCH, the plurality of RS, the control data sequence, and the user data sequence, to generate a multiplexed sequence which may not be circular. The multiplexed sequence is fed to the OTFDM symbol generating unit 104 as shown in FIG. 1B and the output 134 is fed to the processing unit of FIG. 1C to generate a OTFDM symbol. In an embodiment, the generated OTFDM symbols are specific to a particular antenna. The symbol generated is transmitted by one of a specific antenna from the plurality of antennas.

In another embodiment, the generated OTFDM waveform undergoes a procedure known as Antenna precoding, where the purpose of precoding is to map the generated OTFDM symbols to a set of antenna ports using a precoder matrix. The generated OTFDM signal is multiplied using antenna port specific phase weights and each weighted signal is transmitted using an antenna port. Each complex weighted baseband OTFDM signal is converted to analog waveform using digital to analog converter (DAC). The analog OTFDM waveform undergoes power amplification to boost the signal strength to a level capable of transmission across the air interface. Since, OTFDM signal has low PAPR, the PA requires low back off, thereby resulting in energy efficient transmission. For pi/2 BPSK OTFDM the back off may be 0 dB or very low value so that signal can be transmitted close to power amplifier (PA) saturation power. Digital pre distortion operation may be used before PA when higher order modulation is used. Further the OTFDM waveform undergoes radio frequency (RF) filtering subsequently transmitted through the antenna array.

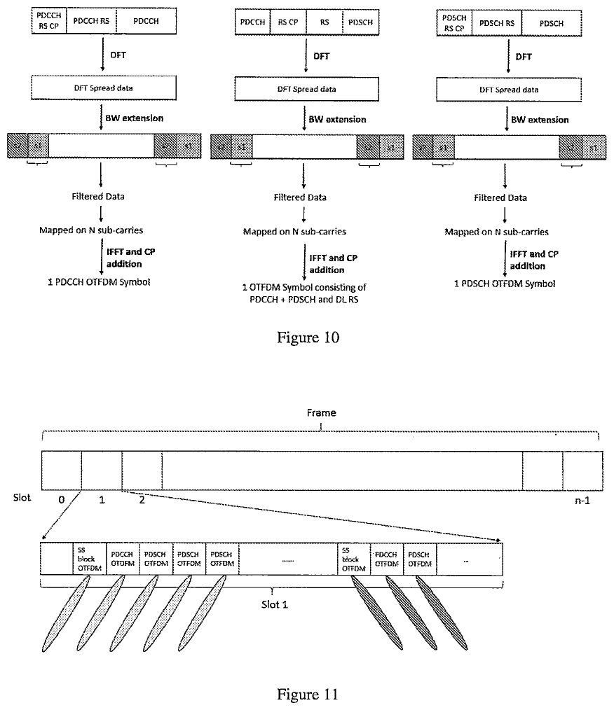

FIG. 10 shows an illustration of generation of DL OTFDM symbols. In the left figure, an OTFDM symbol is generated using only PDCCH RS CP, PDCCH RS and PDCCH. In the figure in center, it describes the generation of an OTFDM symbol where PDCCH and PDSCH are time multiplexed along with DL RS. The figure on the right end is shows generation of an OTFDM symbol consisting of PDSCH, PDSCH RS and PDSCH RS CP. The input symbol structures shown in FIG. 10 are only for illustration purpose. The input sequences are processed using DFT, DFT spreaded with bandwidth extension, followed by filtering, mapping, IFFT and CP addition to generate an OTFDM symbol. The PDCH data may optionally include PT-RS for phase compensation at the receiver.

In an embodiment, the input symbols are any of the symbol structure as shown in FIGS. 5B, 6A to 6H, 7A to 7D, 7F, 8A to 8C. These input symbols are cyclic in nature in an embodiment. The input sequences are processed using DFT, DFT spreaded with bandwidth extension, followed by filtering, mapping, IFFT to generate an OTFDM symbol. For the input symbols which are cyclic, the processing does not include the step of CP addition to generate the OTFDM symbol.

FIG. 11 shows allocation of SS block, PDCCH and PDSCH OTFDM symbols in a slot with their associated beam, where a slot has N symbols. As shown in FIG. 11, multiple DL OTFDM symbols are transmitted in a slot within a frame. Also in FIG. 11, a slot consists of N symbols. Each symbol is associated with a beam thus enabling different beam directions for the DL OTFDM symbols.

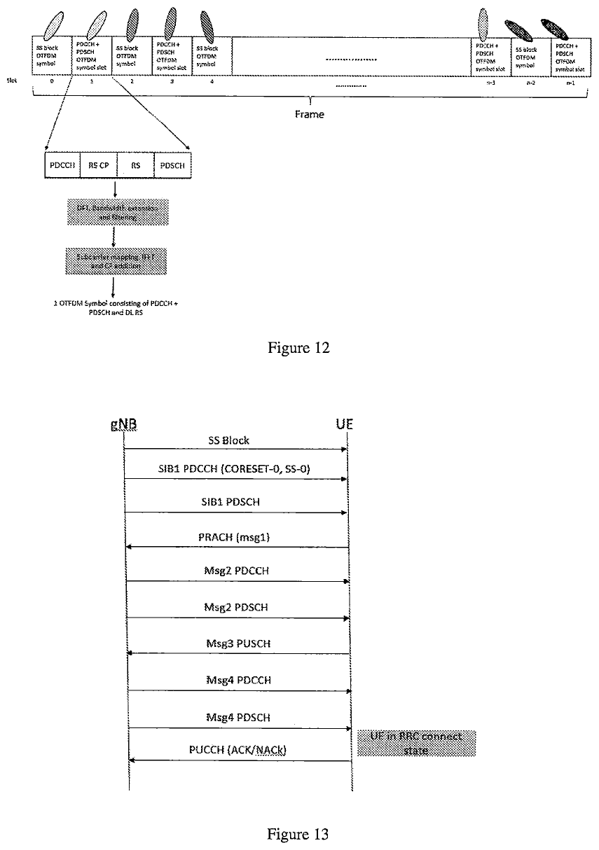

FIG. 12 shows allocation of SS block, PDCCH and PDSCH OTFDM symbols in a frame with their associated beam, where a slot consisting of 1 OTFDM symbol. As shown in FIG. 12, the transmission of DL OTFDM symbols is in one frame. There are n slots in a frame and each slot is consisting of 1 OTFDM symbol. The symbol in each slot is associated with a beam as shown in the FIG. 12.

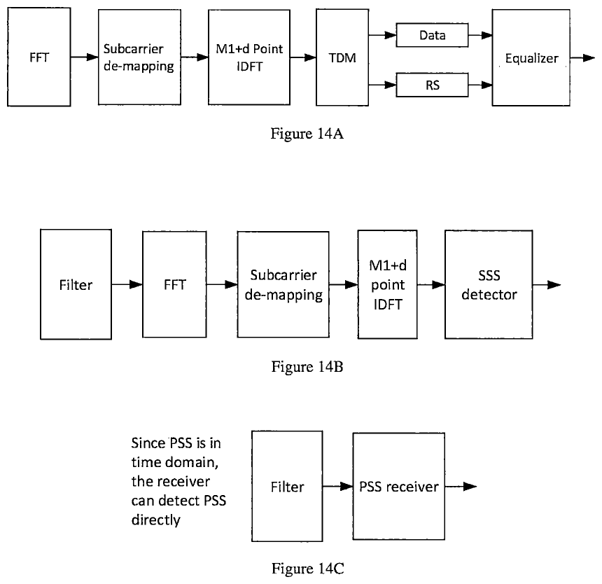

FIG. 13 shows the flow of different messages between a UE and a gNB till RRC connection is established. The UE is referred to as a user. The gNB is a base station or BS. The SS block consists of PSS, SSS and PBCH. The PSS and SSS together conveys the gNB ID or the physical Cell ID. PBCH conveys Master Information Block (MIB). The MIB includes information such as Control Resource Set 0 (CORESET-0) and Search Space 0 (SS-0) location required to decode PDCCH associated with the (System Information Block-1) SIB1 PDSCH, subcarrier spacing configuration to be used for SIB1, msg2/msg4 for initial access, paging and broadcast SI messages, System Frame Number (SFN) etc. SS blocks associated with different beam IDs are allocated different symbol start locations within a half frame.

The base station transmits these synchronization signal blocks using directional beams. The UE detects one of the SS block beams and the detected beam conveys the symbol location within a half frame to the UE and hence providing the timing information at symbol level granularity. Once MIB is decoded, to get the Remaining Minimum System Information (RMSI) required to access the system, the UE needs to detect the System Information Block-1. The information conveyed by MIB is used to find the CORESET-0 and SS-0 locations which provides the possible location to look for PDCCH. SIB1 PDCCH is scrambled by SI RNTI. The UE blind decoded PDCCH to get Downlink Control information (DCI). The DCI contains information required to decode the corresponding SIB1 PDSCH, such as, time-frequency allocation, Modulation and Coding Scheme, Redundancy version etc. Using this information, a UE decodes SIB1 PDSCH. In SIB1 the gNB transmits the information required by the UE to carry out the initial Random Access Procedure and enables further processing till the RRC attach.

Once the user successfully decodes the SIB-1, it gets to know the time/frequency locations (known as PRACH occasions) where it can perform the initial random access procedure. It picks a preamble-id and performs the random access (or sends message-1) based on the RACH occasions defined in the SIB-1. In the subsequent step, the base station sends the message-2 (or the Random Access Response (RAR)) in the downlink and scrambles the RAR with the random access RNTI (RA-RNTI). This RA-RNTI depends on the PRACH occasions or the time-frequency resources where message-1 has been received. Later on, in message-3 and message-4, the device and the base station exchange messages to resolve the collisions caused due to picking of the same preamble-id by the users. Once the collision is resolved, the user enters the connected state and the communication between the base station and the user can happen using regular dedicated transmissions.

One embodiment of the present disclosure is a method for transmitting a PDCCH-PDSCH Orthogonal time frequency-division multiplexing (OTFDM) symbol. The order in which the method steps is described is not intended to be construed as a limitation, and any number of the described method steps can be combined in any order to implement the method. Additionally, individual method steps may be deleted from the methods without departing from the scope of the subject matter described herein. Furthermore, the method can be implemented in any suitable hardware, software, firmware, or combination thereof.

The method comprising time-multiplexing, by the transmitter, a physical downlink control channel (PDCCH) sequence, a physical downlink shared channel (PDSCH) sequence and a reference sequence (RS) to generate a multiplexed sequence. The method also comprises processing the time multiplexed sequence to generate a PDCCH-PDSCH OTFDM symbol.

The method of processing the multiplexed sequence to generate a PDCCH-PDSCH OTFDM symbol comprising transforming the multiplexed sequence using a Discrete Fourier Transform (DFT) to generate a transformed multiplexed sequence. Also, the method comprises performing padding operation by prefixing the transformed multiplexed sequence with a first predefined number (N1) of subcarriers and post-fixing the transformed multiplexed sequence with a second predefined number (N2) of subcarriers to obtain an extended bandwidth transformed multiplexed sequence. Further the method comprises, mapping the extended bandwidth transformed multiplexed sequence with at least one of localized and distributed subcarriers to generate a mapped extended bandwidth transformed multiplexed sequence, which is shaped using a filter to obtain a shaped extended bandwidth transformed multiplexed sequence. Furthermore, the method comprises performing an Inverse Fast Fourier Transform (IFFT) on the shaped extended bandwidth transformed multiplexed sequence to produce a time domain sequence. The time domain sequence is processed to generate the PDCCH-PDSCH OTFDM symbol.

The processing the time domain sequence to generate a OTFDM symbol comprises performing at least one of addition of symbol cyclic prefix, addition of symbol cyclic suffix, phase compensation for each symbol by multiplying with a symbol specific exponential value, windowing, weighted with overlap and add operation (WOLA), bandwidth parts (BWP) rotation, additional time domain filtering, sampling rate up-conversion to match DAC rate and frequency shifting on the time domain waveform, to generate the PDCCH-PDSCH OTFDM symbol.

The duration of the PDCCH sequence and the PDSCH sequences is unequal. The PDCCH carries a common control information and a user specific control information. The PDSCH carries a user specific data. The RS is used to demodulate the PDCCH and PDSCH by one or more receiving users or user equipment's (UEs).

One embodiment of the present disclosure is a method for transmitting a PDSCH Orthogonal time frequency-division multiplexing (OTFDM) symbol. The method, performed by a transmitter 500, comprising time-multiplexing a physical downlink shared channel (PDSCH) sequence and a reference sequence (RS) to generate a multiplexed sequence and processing the multiplexed sequence to generate a PDSCH OTFDM symbol. The PDSCH carries a user specific data. The RS is used to demodulate the PDSCH by one or more receiving users or user equipment's (UEs).

In another embodiment, a method for transmitting a PDCCH Orthogonal time frequency-division multiplexing (OTFDM) symbol is provided. The method, performed by a transmitter 500, comprises time-multiplexing a physical downlink control channel (PDCCH) sequence and a reference sequence (RS) to generate a multiplexed sequence. Also, the method comprises processing the multiplexed sequence to generate a PDCCH OTFDM symbol. The PDCCH carries a common control information and a user specific control information. The RS is used to demodulate the PDCCH by one or more receiving users or user equipment's (UEs).

One embodiment of the present disclosure is a method for transmitting a PDCCH-PDSCH Orthogonal time frequency-division multiplexing (OTFDM) slot. The method comprising time-multiplexing, by the transmitter 500, a PDCCH-PDSCH OTFDM symbol and a plurality of PDSCH OTFDM symbols to generate a PDCCH-PDSCH Orthogonal time frequency-division multiplexing (OTFDM) slot. The PDCCH-PDSCH slot comprises a control information and a data information intended for one or more receiving users or user equipment's (UEs). The one or more receiving users decode the control information and the data information using the received PDCCH-PDSCH slot.

One embodiment of the present disclosure is a method for transmitting a PDCCH-PDSCH Orthogonal time frequency-division multiplexing (OTFDM) slot. The method comprising time-multiplexing, by the transmitter, a PDCCH OTFDM symbol, a plurality of PDSCH OTFDM symbols to generate a PDCCH-PDSCH Orthogonal time frequency-division multiplexing (OTFDM) slot. The PDCCH-PDSCH slot comprises a control information and a data information intended for one or more receiving users. The one or more receiving UEs or user equipment's (UEs) decode the control information and the data information using the received PDCCH-PDSCH slot.

One embodiment of the present disclosure is a method for transmitting a downlink frame. The method comprises time-multiplexing, by the transmitter, at least one SS Block and at least PDCCH-PDSCH OTFDM slot to generate at least one downlink signal associated with a beam. The users or user equipment's (UEs) associated with the beam decode a SS Block and acquire PSS ID/BS ID, and MIB. Also, the users associated with the beam decode one of corset zero, SIB1, and user data using the received DL signal associated with the beam.

One embodiment of the present disclosure is a method for transmitting a downlink frame. The method comprising time-multiplexing, by the transmitter, a plurality of SS Blocks associated with a plurality of beams and a plurality of PDCCH-PDSCH OTFDM symbols associated with a plurality of beam to generate a downlink frame. The users associated with the beam decode a SS Block and acquire PSS ID/BS ID, and MIB. The users associated with the beam decode one of corset zero, SIB1, and user data using the received DL signal associated with the beam.

One embodiment of the present disclosure is a receiver. The receiver structures are as shown in FIGS. 14A, 14B and 14C.

FIG. 14A shows a block diagram representation of a receiver, in accordance with an embodiment of the present disclosure. As shown in FIG. 14A, the receiver is for channels like PDSCH, PDCCH, and for PBCH decoding. Here, post CP removal of the OTFDM symbol at the receiver, the received data is processed with sub-carrier de-mapper, where the data corresponding to each user for each channels mentioned above are de-mapped. The de-mapped data is processed with M1+d point IDFT, which is followed by Time domain demultiplexer for each user. Here, the RS corresponding to each user is separated. The received RS samples are used for channel estimation, phase tracking, Doppler compensation CQI measurements, and data/control detection.

FIG. 14B shows the receiver block diagram for SSS receiver, where the initial processing till taking IDFT of size M1+d on the de-mapped data is similar to the PDSCH channel. Post IDFT SSS receiver is applied on the data operated with IDFT. FIG. 14C shows a block diagram representation of a PSS receiver, in accordance with yet another embodiment of the present disclosure. Since PSS is in time domain, the receiver can detect PSS directly.

In an embodiment, a method for transmitting a PDCCH-PDSCH Orthogonal time frequency-division multiplexing (OTFDM) symbol is disclosed. The method comprising: time-multiplexing, by the transmitter, at least one of a physical downlink control channel (PDCCH) sequence, a physical downlink shared channel (PDSCH) sequence, a reference sequence (RS), and a portion of at least one of the PDCCH sequence, the PDSCH sequence and the RS to generate a multiplexed sequence; and filtering, by the transmitter, the multiplexed sequence to generate a PDCCH-PDSCH OTFDM symbol. Duration of the PDCCH sequence and the PDSCH sequences is unequal. The PDCCH carries a common control information and a user specific control information. The PDSCH carries a user specific data. The RS is used to demodulate the PDCCH and PDSCH by one or more receiving users.

The filtering the multiplexed sequence to generate a PDCCH-PDSCH OTFDM symbol comprising transforming the multiplexed sequence using a Discrete Fourier Transform (DFT) to generate a transformed multiplexed sequence; performing padding operation by prefixing the transformed multiplexed sequence with a first predefined number (N1) of subcarriers and post-fixing the transformed multiplexed sequence with a second predefined number (N2) of subcarriers to obtain an extended bandwidth transformed multiplexed sequence; mapping the extended bandwidth transformed multiplexed sequence with at least one of localized and distributed subcarriers to generate a mapped extended bandwidth transformed multiplexed sequence; shaping the mapped extended bandwidth transformed multiplexed sequence using a filter to obtain a shaped extended bandwidth transformed multiplexed sequence; performing an Inverse Fast Fourier Transform (IFFT) on the shaped extended bandwidth transformed multiplexed sequence to produce a time domain sequence; and processing the time domain sequence to generate the PDCCH-PDSCH OTFDM symbol. The value of the N1 is at least zero, and value of the N2 is at least zero. The transformed multiplexed sequence is mapped using one of localized and distributed subcarriers.

The filtering is performed on the time domain sequence to generate a OTFDM symbol. The filtering comprises performing at least one of addition of symbol cyclic prefix, addition of symbol cyclic suffix, phase compensation for each symbol by multiplying with a symbol specific exponential value, windowing, weighted with overlap and add operation (WOLA), bandwidth parts (BWP) rotation, additional time domain filtering, sampling rate up-conversion to match DAC rate and frequency shifting on the time domain waveform, to generate the PDCCH-PDSCH OTFDM symbol.

In an embodiment, the filtering of the multiplexed sequence to generate the OTFDM symbol comprises filtering the multiplexed sequence using circular pulse shaping filter to generate filtered sequence; performing weighted with overlap and add operation (WOLA) on the filtered sequence to generate WOLA sequence; and converting the WOLA sequence using the digital analog converter (DAC) to generate OTFDM symbol. In another embodiment, the filtering of the multiplexed sequence to generate the OTFDM symbol is performed using a linear filter.

One embodiment of the present disclosure is a method for transmitting a PDSCH Orthogonal time frequency-division multiplexing (OTFDM) symbol. The method comprising: time-multiplexing, by the transmitter, a physical downlink shared channel (PDSCH) sequence, a reference sequence (RS), and a portion of at least one of the PDSCH sequence and the RS to generate a multiplexed sequence; and filtering the multiplexed sequence to generate a PDSCH OTFDM symbol. The PDSCH carries a user specific data. The RS is used to demodulate the PDSCH by one or more receiving users.

One embodiment of the present disclosure is a method for transmitting a PDCCH Orthogonal time frequency-division multiplexing (OTFDM) symbol. The method comprising time-multiplexing, by the transmitter, a physical downlink control channel (PDCCH) sequence, a reference sequence (RS) and at least one of the PDCCH portion and the RS to generate a multiplexed sequence; and filtering the multiplexed sequence to generate a PDCCH OTFDM symbol. The PDCCH carries a common control information and a user specific control information. The RS is used to demodulate the PDCCH by one or more receiving users.

One embodiment of the present disclosure is a method for transmitting a PDCCH-PDSCH Orthogonal time frequency-division multiplexing (OTFDM) slot. The method comprising time-multiplexing, by the transmitter, a PDCCH-PDSCH OTFDM symbol and a plurality of PDSCH OTFDM symbols to generate a PDCCH-PDSCH Orthogonal time frequency-division multiplexing (OTFDM) slot. The PDCCH-PDSCH slot comprises a control information and a data information intended for one or more receiving users. The one or more receiving users decode the control information and the data information using the received PDCCH-PDSCH slot.

One embodiment of the present disclosure is a method for transmitting a PDCCH-PDSCH Orthogonal time frequency-division multiplexing (OTFDM) slot. The method comprises time-multiplexing, by the transmitter, a PDCCH OTFDM symbol, a plurality of PDSCH OTFDM symbols to generate a PDCCH-PDSCH Orthogonal time frequency-division multiplexing (OTFDM) slot. The PDCCH-PDSCH slot comprises a control information and a data information intended for one or more receiving users. The one or more receiving UEs decode the control information and the data information using the received PDCCH-PDSCH slot.

One embodiment of the present disclosure is a method for transmitting a downlink frame. The method comprises time-multiplexing at least one SS Block and at least PDCCH-PDSCH OTFDM slot to generate at least one downlink signal associated with a beam. The users associated with the beam decode a SS Block and acquire PSS ID/BS ID, and MIB. The users associated with the beam decode one of corset zero, SIB1, and user data using the received DL signal associated with the beam.

One embodiment of the present disclosure is a method for transmitting a downlink frame. The method comprising time-multiplexing, by the transmitter, a plurality of SS Blocks associated with a plurality of beams and a plurality of PDCCH-PDSCH OTFDM symbols associated with a plurality of beam to generate a downlink frame. The users associated with the beam decode a SS Block and acquire PSS ID/BS ID, and MIB. The users associated with the beam decode one of corset zero, SIB1, and user data using the received DL signal associated with the beam.

Further, the code implementing the described operations may be implemented in “transmission signals”, where transmission signals may propagate through space or through a transmission media, such as an optical fiber, copper wire, etc. The transmission signals in which the code or logic is encoded may further comprise a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a non-transitory computer readable medium at the receiving and transmitting stations or devices. An “article of manufacture” comprises non-transitory computer readable medium, hardware logic, and/or transmission signals in which code may be implemented. A device in which the code implementing the described embodiments of operations is encoded may comprise a computer readable medium or hardware logic. Of course, those skilled in the art will recognize that many modifications may be made to this configuration without departing from the scope of the invention, and that the article of manufacture may comprise suitable information bearing medium known in the art.

A description of an embodiment with several components in communication with each other does not imply that all such components are required. On the contrary a variety of optional components are described to illustrate the wide variety of possible embodiments of the invention.

When a single device or article is described herein, it will be clear that more than one device/article (whether they cooperate) may be used in place of a single device/article. Similarly, where more than one device or article is described herein (whether they cooperate), it will be clear that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

Finally, the language used in the specification has been principally selected for readability and instructional purposes, and it may not have been selected to delineate or circumscribe the inventive subject matter. It is therefore intended that the scope of the invention be limited not by this detailed description. Accordingly, the disclosure of the embodiments of the invention is intended to be illustrative, but not limiting, of the scope of the invention.

While various aspects and embodiments have been disclosed herein, other aspects and embodiments will be apparent to those skilled in the art. The various aspects and embodiments disclosed herein are for purposes of illustration and are not intended to be limiting.

What is claimed is:

1. A method for transmitting synchronization signal (SS) Block Orthogonal time frequency-division multiplexing (OTFDM) symbol, comprising:
time-multiplexing, by the transmitter, at least one of a primary synchronization signal (PSS) sequence, a secondary synchronization signal (SSS) sequence, a physical broadcast channel (PECH) sequence, and a portion of the at least one of PSS sequence, SSS sequence and PECH sequence to generate a multiplexed sequence; and
filtering, by the transmitter, the multiplexed sequence to generate a SS Block OTFDM symbol.

2. The method as claimed in claim 1, wherein the SS Block OTFDM symbol is one of a PSS OTFDM symbol comprising of only PSS sequence, a SSS OTFDM symbol comprising of only SSS sequence, a PECH OTFDM symbol comprising of only PECH sequence; and an OTFDM symbol comprising of the PSS sequence, the SSS sequence, the PECH sequence and a portion of the at least one of PSS sequence, SSS sequence and PECH sequence.

3. The method as claimed in claim 1, wherein the PSS sequence includes one of a PSS cyclic prefix (CP), and a PSS CP along with a PSS cyclic suffix (CS).

4. The method as claimed in claim 1, wherein the SSS sequence includes one of a SSS CP and a SSS CP along with a SSS CS.

5. The method as claimed in claim 1, wherein the PECH sequence includes one of a PECH CP, and a PECH CP along with PECH CS.

6. The method as claimed in claim 1, wherein the PECH sequence includes a PECH DMRS, said PECH DMRS includes at least one of a PECH DMRS CP and a PECH DMRS CS.

7. The method as claimed in claim 6, wherein the PECH DMRS is one of a pi/2 BPSK, a QPSK, and a ZC, wherein the PECH data is one of a pi/2 BPSK and a QPSK.

8. The method as claimed in claim 1, wherein the PSS sequence is a function of sector id or Base station id, wherein the PSS sequence is one sequence for all sectors or one of N possible sequences, wherein N is an integer.

9. The method as claimed in claim 1, wherein the PSS sequence is one of pi/2 BPSK and ZC; wherein the SSS sequence is one of pi/2 BPSK and ZC.

10. The method as claimed in claim 1, wherein the PSS sequence comprise a base sequence repeated for a predefined number of times, wherein each of the repeated based sequence is multiplied with an element of a code cover sequence.

11. The method as claimed in claim 1, wherein the SSS sequence comprises of a base sequence repeated for a predefined number of times, wherein each of the repeated based sequence is multiplied with an element of a code cover sequence.

12. The method as claimed in claims 10- or 11, the wherein the predefined number is one of 1, 2, 4 or more.

13. The method as claimed in claim 1, wherein filtering the multiplexed sequence to generate the OTFDM symbol comprising:
transforming the multiplexed sequence using a Discrete Fourier Transform (DFT) to generate a transformed multiplexed sequence;
performing padding operation by prefixing the transformed multiplexed sequence with a first predefined number (N1) of subcarriers and post-fixing the transformed multiplexed sequence with a second predefined number (N2) of subcarriers to obtain an extended bandwidth transformed multiplexed sequence;
mapping the extended bandwidth transformed multiplexed sequence with at least one of localized and distributed subcarriers to generate a mapped extended bandwidth transformed multiplexed sequence;
shaping the mapped extended bandwidth transformed multiplexed sequence using a filter to obtain a shaped extended bandwidth transformed multiplexed sequence;
performing an Inverse Fast Fourier Transform (IFFT) on the shaped extended bandwidth transformed multiplexed sequence to produce a time domain sequence; and
processing the time domain sequence to generate the OTFDM symbol.

14. The method as claimed in claim 13, wherein value of the N1 is at least zero, and value of the N2 is at least zero.

15. The method as claimed in claim 13, wherein the transformed multiplexed sequence is mapped using one of localized and distributed subcarriers.

16. The method as claimed in claim 13, wherein processing the time domain sequence to generate a OTFDM symbol comprises performing at least one of addition of symbol cyclic prefix, addition of symbol cyclic suffix, phase compensation for each symbol by multiplying with a symbol specific exponential value, windowing, weighted with overlap and add operation (WOLA), bandwidth parts (BWP) rotation, additional time domain filtering, sampling rate up-conversion to match DAC rate and frequency shifting on the time domain waveform, to generate the OTFDM symbol.

17. The method as claimed in claim 1, wherein filtering the multiplexed sequence to generate the OTFDM symbol comprising:
filtering the multiplexed sequence using circular pulse shaping filter to generate filtered sequence;
performing weighted with overlap and add operation (WOLA) on the filtered sequence to generate WOLA sequence; and
converting the WOLA sequence using the digital analog converter (DAC) to generate OTFDM symbol.

18. The method as claimed in claim 1, wherein filtering the multiplexed sequence to generate the OTFDM symbol is performed using a linear filter.

19. A method for transmitting OTFDM SS burst, comprising:
time-multiplexing, by the transmitter, a plurality of OTFDM SS Blocks to generate multiplexed OTFDM SS blocks, wherein each of the plurality of OTFDM SS Blocks is associated with a different beam; each of the plurality of OTFDM SS Blocks is generated by:
time-multiplexing, by the transmitter, at least one of a primary synchronization signal (PSS) sequence, a secondary synchronization signal (SSS) sequence, a physical broadcast channel (PECH) sequence, and a portion of the at least one of PSS sequence, SSS sequence and PECH sequence to generate a multiplexed sequence; and
filtering, by the transmitter, the multiplexed sequence to generate a SS Block OTFDM symbol.

20. The method as claimed in claim 19, wherein the OTFDM SS burst is transmitted through a predefined number of beams, wherein the multiplexed SS blocks are transmitted in succession one for each beam, said predefined number is one of 1, 8, 16, 32, 64, and 128.

21-33. (canceled)
